(19) United States
(12) Patent Application Publication
(10) Pub. No.: US 2026/0220484 A1
(43) Pub. Date: Jul. 30, 2026

(54) CLIENT DEVICE AND METHOD FOR PARTICIPATING IN FEDERATED LEARNING OF A NEURAL NETWORK

(71) Applicant: FRAUNHOFER-GESELLSCHAFT ZUR FOERDERUNG DER ANGEWANDTEN FORSCHUNG E.V., Muenchen (DE)

(72) Inventors: Daniel BECKING, Berlin (DE); Paul HAASE, Berlin (DE); Gerhard TECH, Berlin (DE); Heiner KIRCHHOFFER, Berlin (DE); Karsten MUELLER, Berlin (DE); Wojciech SAMEK, Berlin (DE); Heiko SCHWARZ, Berlin (DE); Detlev MARPE, Berlin (DE); Thomas WIEGAND, Berlin (DE)

(21) Appl. No.: 19/424,354

(22) Filed: Dec. 18, 2025

Related U.S. Application Data
(63) Continuation of application No. PCT/EP2024/067156, filed on Jun. 19, 2024.

(30) Foreign Application Priority Data
Jun. 19, 2023 (EP) 23180183.8

(51) Int. Cl. G06N 3/098; G06N 3/084

(52) U.S. Cl. CPC G06N 3/098; G06N 3/084

(57) ABSTRACT

A client device and method for participating in federated learning of a neural network are presented. The client device is configured to perform, using a data set and starting from a current state of a parametrization of the neural network, a training of the neural network to obtain an advanced state of the parametrization, and compute a difference between the advanced state of the parametrization or a re-parametrized-domain advanced state thereof derived by means of re-parametrization mapping and the current state of a parametrization or re-parametrized-domain current state thereof to obtain a local difference, to send a differential update to a server, having the local difference and receive an averaged update from the server, having a received averaged difference, and to update the current state of the parametrization to obtain an updated state of the parametrization using a local parametrization, and a further parametrization.

### CROSS-REFERENCE TO RELATED APPLICATIONS

This application is a continuation of copending International Application No. PCT/EP2024/067156, filed Jun. 19, 2024, which is incorporated herein by reference in its entirety, and additionally claims priority from European Application No. 23180183.8, filed Jun. 19, 2023, which is also incorporated herein by reference in its entirety.

### TECHNICAL FIELD

Embodiments according to the invention relate to client devices and methods for participating in federated learning of a neural network using a local and further parametrization, e.g., using a concept for improved parameter update in federated learning applications.

### BACKGROUND OF THE INVENTION

In their most basic form, neural networks constitute a chain of affine transformations followed by an element-wise non-linear function. They may be represented as a directed acyclic graph, as depicted in FIG. 1. Each node entails a particular value, which is forward propagated into the next node by multiplication with the respective weight value of the edge. All incoming values are then aggregated.

FIG. 1 shows an example for a graph representation of a feed forward neural network. Specifically, this 2-layered network is a non-linear function which maps a 4-dimensional input vector to a scalar output.

Mathematically, the neural network of FIG. 1 would calculate the output in the following manner:

$$output = {L}_{2} ( {L}_{1} ( input ) )$$

$$where$$

$${L}_{i} ( X ) = {F}_{i} ( {B}_{i} ( X ) )$$

and where Bᵢ is the affine transformation (e.g., comprising a linear mapping and a translational mapping) of layer i and where Fᵢ is some non-linear function of layer i.

### Biased Layers

In the case of a so-called ‘biased layer’, Bᵢ is a matrix multiplication of weight parameters (edge weights) Wᵢ associated with layer i with the input Xᵢ of layer i followed by a summation with a bias bᵢ:

$${B}_{i} ( X ) = {W}_{i} * {X}_{i} + {b}_{i}$$

Wᵢ is a weight matrix with dimensions nᵢ×kᵢ and Xᵢ is the input matrix with dimensions kᵢ×mᵢ. Bias bᵢ is a transposed vector (e.g., a row vector) of length nᵢ. The operator * shall denote matrix multiplication. The summation with bias bᵢ is an element-wise operation on the columns of the matrix. More precisely, Wᵢ*Xᵢ+bᵢ means that bᵢ is added to each column of Wᵢ*Xᵢ.

So-called convolutional layers may also be used by casting them as matrix-matrix products as described in (Chetlur et al., 2014). From now on, we will refer as inference the procedure of calculating the output from a given input. Also, we will call intermediate results as hidden layers or hidden activation values, which constitute a linear transformation+element-wise non-linearity, e.g., such as the calculation of the first dot product+non-linearity above.

### Batch Normalization Layers

A more sophisticated variant of affine transformation of a neural network layer's output is the so-called bias- and batch-normalization (Ioffe & Szegedy, 2015) operation:

$$\begin{matrix}Equation 1 & \\ BN ( X ) = \frac{B ( X ) - μ}{\sqrt{{σ}^{2} + ϵ}} \cdot γ + β = \frac{W * X + b - μ}{\sqrt{{σ}^{2} + ϵ}} \cdot γ + β & equation ( 1 )\end{matrix}$$

where μ, σ², γ, and β are denoted batch norm parameters. Note that layer indexes i are neglected here. W is a weight matrix with dimensions n×k and X is the input matrix with dimensions k×m. Bias b and batch norm parameters μ, σ², γ, and β are transposed vectors of length n. Operator * denotes a matrix multiplication. Note that all other operations (summation, multiplication, division) on a matrix with a vector are element-wise operations on the columns of the matrix. For example, X. γ means that each column of X is multiplied element-wise (e.g., a Hadamard product) with γ. ϵ is a small scalar number (like, e.g., 0.001) required to avoid divisions by 0. However, it may also be 0.

In the case where all vector elements of b equal zero, Equation 1 refers to a batchnorm layer.

In contrast, if ϵ and all vector elements of μ and β are set to zero and all elements of γ and σ² are set to 1, a layer without batch norm (bias only) is addressed.

### Efficient Representation of Parameters

The parameters W, b, μ, σ², γ, and β shall collectively be denoted parameters of a layer. They usually need to be signaled in a bitstream. For example, they could be represented as 32 bit floating point numbers or they could be quantized to an integer representation. Note that ϵ is usually not signaled in the bitstream.

A particularly efficient approach for encoding such parameters employs a uniform reconstruction quantizer where each value is represented as integer multiple of a so-called quantization step size value. The corresponding floating point number can be reconstructed by multiplying the integer with the quantization step size, which is usually a single floating point number. However, efficient implementations for neural network inference employ integer operations whenever possible. Therefore, it may be undesirable to require parameters to be reconstructed to a floating point representation.

### Federated Averaging

In Federated Averaging (McMahan et al., 2017), a common global neural network is trained by N client devices, each having their own training data subset. The training is orchestrated by a server which aggregates the clients' updated weights

$${W}_{c}^{*} ,$$

c∈N, by averaging them.

Alternatively, differential weight updates may be transmitted and averaged. Differential weight updates are computed by subtracting a prior state of the base neural network from an updated state of the base neural network layer-wise, e.g.,

$$Δ {W}_{i} = {W}_{i}^{*} - {W}_{i}$$

for W of layer i. A server update ΔWₛ is then transmitted to the N client devices and added to their prior base model's state. Then, the clients perform one round of training using their local training data, generate a model update

$${W}_{c}^{*} ,$$

calculate the difference ΔW_{c} with respect to the pre-training base model state W_{c} and upload their deltas to the server, which performs aggregation again.

Due to frequent weight update transmissions of a potentially large number of clients #N, a huge amount of data must be communicated. Therefore, compression of neural update data can reduce the system's latency and can even save energy through shorter up- and download times.

Due to the more centralized distributions of differential weight updates ΔWᵢ, they are usually higher compressible than the original, full weights

$${W}_{i}^{*} .$$

However, this is not necessarily true for other parameters of a layer, e.g., μ, σ², γ, and β. Furthermore, repeated updating of parameters at the client devices requires successful transmission of the server updates. Late or a failure of transmission of the server updates may cause a drifting of the weights, which may slow down a training progress and/or reduce a quality of the training.

Therefore, there is a need for an improved compromise between coding efficiency and coding stability.

Thus, in this invention a method for improved compressibility and/or stability of batch norm parameters in Federated Averaging applications is described.

### SUMMARY

An embodiment may have a client device for participating in federated learning of a neural network, configured to perform, using a data set and starting from a current state of a parametrization of the neural network, a training of the neural network to obtain an advanced state of the parametrization; compute a difference between the advanced state of the parametrization or a re-parametrized-domain advanced state of the parametrization derived from the advanced state of the parametrization by means of a re-parametrization mapping and the current state of a parametrization or a re-parametrized-domain current state of the parametrization to obtain a local difference; send a differential update to a server, the differential update having the local difference; receive an averaged update from the server, the averaged update having a received averaged difference; update the current state of the parametrization to obtain an updated state of the parametrization using a local parametrization obtained depending on one of the current state of the parametrization, the re-parametrized-domain current state of the parametrization, the advanced state of the parametrization or the re-parametrized-domain advanced state of the parametrization, and a further parametrization obtained depending on the received averaged difference and one of the current state of the parametrization, the re-parametrized-domain current state of the parametrization, the re-parametrized-domain advanced state of the parametrization or the advanced state of the parametrization.

According to another embodiment, a method for participating in federated learning of a neural network may have the steps of: performing, using a data set and starting from a current state of a parametrization of the neural network, a training of the neural network to obtain an advanced state of the parametrization; computing a difference between the advanced state of the parametrization or a re-parametrized-domain advanced state of the parametrization derived from the advanced state of the parametrization by means of a re-parametrization mapping and the current state of a parametrization or a re-parametrized-domain current state of the parametrization to obtain a local difference; sending a differential update to a server, the differential update having the local difference; receiving an averaged update from the server, the averaged update having a received averaged difference; updating the current state of the parametrization to obtain an updated state of the parametrization using a local parametrization obtained depending on one of the current state of the parametrization, the re-parametrized-domain current state of the parametrization, the advanced state of the parametrization or the re-parametrized-domain advanced state of the parametrization, and a further parametrization obtained depending on the received averaged difference and one of the current state of the parametrization, the re-parametrized-domain current state of the parametrization, the re-parametrized-domain advanced state of the parametrization or the advanced state of the parametrization.

According to still another embodiment, a system for federated averaging learning of a batch normalization neural network may have: a server, and one or more client devices according to the invention as mentioned above.

According to an aspect, a client device for participating in federated learning of a neural network is provided. The client device is configured to perform, using a data set and starting from a current state of a parametrization of the neural network, a training of the neural network to obtain an advanced state of the parametrization. The client device is further configured to compute a difference between the advanced state of the parametrization or a re-parametrized-domain advanced state of the parametrization derived from the advanced state of the parametrization by means of a re-parametrization mapping and the current state of a parametrization or a re-parametrized-domain current state of the parametrization to obtain a local difference. The client device is further configured to send a differential update to a server, the differential update comprising the local difference and to receive an averaged update from the server, the averaged update comprising a received averaged difference. The client device is configured to update the current state of the parametrization to obtain an updated state of the parametrization using a local parametrization obtained depending on one of the current state of the parametrization, the re-parametrized-domain current state of the parametrization, the advanced state of the parametrization or the re-parametrized-domain advanced state of the parametrization, and a further parametrization obtained depending on the received averaged difference and one of the current state of the parametrization, the re-parametrized-domain current state of the parametrization, the re-parametrized-domain advanced state of the parametrization or the advanced state of the parametrization.

The training of the data set yields an advanced state of the parametrization that (at least on average) represents a learning progression with improved parameters. The difference is formed between the advanced state and the current state, wherein none, one, or both of the states may be in a re-parametrized domain. Therefore, the difference is indicative of the training progress of the neural network of the client device. The difference may be performed using parameters that are at least partially mapped into the re-parametrization domain, which enables the use of a parametrization that may improve coding efficiency (e.g., by using a re-parametrization that reduces an amount of parameters) and/or transmission reliability (e.g., by using a parametrization that allows deriving, estimating or checking a difference based on other differences, e.g., in case one of the differences fails to be transmitted). The differential update comprises the local difference, which provides the server information that may be indicative (at least one average) of a training progress. As a result, the server can determine an averaged update using the differential update from a plurality of client devices. The average commonly can compensate for occasional, individual advanced states that are over or undertrained and therefore usually forms a reliable basis for an improved training of parameters. However, it has been recognized that the averaged update (and updating the current state using the averaged update) may cause problems that can negatively affect the training. For example, the client device may receive the averaged update at a wrong time (e.g., in a later communication round), which may cause a summation of an incorrect difference. In a different example, the client device may not receive the difference at all, which may cause the current state to be maintained. In more extreme examples, the sending of the differential update may be inadequate (e.g., at the wrong time), which may result in the server determining an incorrect averaged update, which would negatively affect the updating of the current state of the client device. The client device uses the local parametrization and the further parametrization in order to update the current state. Since the further parametrization depends on the averaged difference, a further parametrization can be formed that is indicative of the averaged update and is therefore a parametrization that may be advantageous during proper operation and may be potentially disadvantageous during inadequate operation (e.g., asynchronous transmission between client device(s) and server, e.g., asynchronous base setting). The local parametrization, on the other hand, depends on one of the current state or advance state (either in the re-parametrized state or not) and is therefore indicative of a local training result, which may not be negatively affected by inadequate operation (e.g., asynchronous base setting). Therefore, the client device has access to two different parametrizations with different reliability in regards to inadequate operation. As a result, the training of the neural network may be more reliable. For example, the client device 14 may be configured to identify inadequate operation (e.g., determining itself, for example, by observing network conditions, e.g., by a signalization, e.g., received from the server) and use the further parametrization during adequate operation and the local parametrization during inadequate operation. The client device 14 may, for example, use a combination of the local parametrization and further parametrization, for example a weighted sum of the local and further parametrization. For example, the weighted sum may be fixed or may be adjusted according to the operation. Client device 14 is able to operate in a re-parametrized domain. For example, the further parametrization may use one or parameters in the re-parametrized domain, e.g., in order to reduce data transmission for the differential update and/or the averaged update. However, the local parametrization may also use re-parametrization, e.g., in order to improve compatibility with re-parametrized states used in the further parametrization.

### BRIEF DESCRIPTION OF THE DRAWINGS

The drawings are not necessarily to scale; emphasis instead generally being placed upon illustrating the principles of the invention. In the following description, various embodiments of the invention are described with reference to the following drawings, in which:

FIG. 1 shows an example for a graph representation of a feed forward neural network;

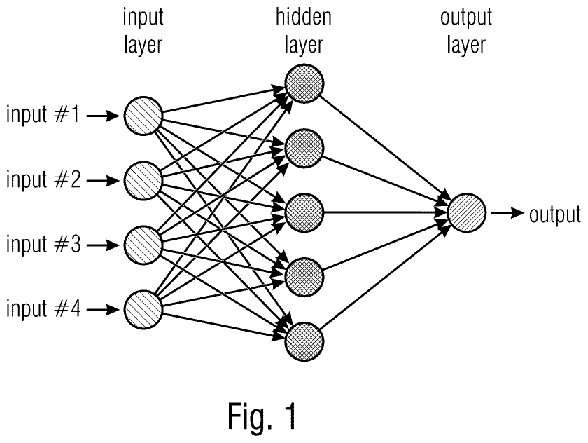

FIG. 2 shows a schematic view of a system for federated averaging learning;

FIG. 3 shows a schematic view of a client device;

FIG. 4 shows an example of a client device with a specific example of states for updating the current state of the parametrization;

FIG. 5 shows an example of a client device for updating a current state of a parametrization of an exemplary parameter;

FIG. 6 shows another example of a client device for updating the current state of the parametrization of an exemplary parameter; and

FIG. 7 shows a schematic flow diagram of a method for participating in federated learning of a neural network.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

Embodiments regarding the update of client neural networks in federated learning are described below. Some relate to BN parametrizations and the corresponding concepts may be named federated BatchNorm folding (FedBNF). They might involve a compression scheme for Batch Normalization parameters. However, the invention is not restricted to BN and compressed parameter transmissions.

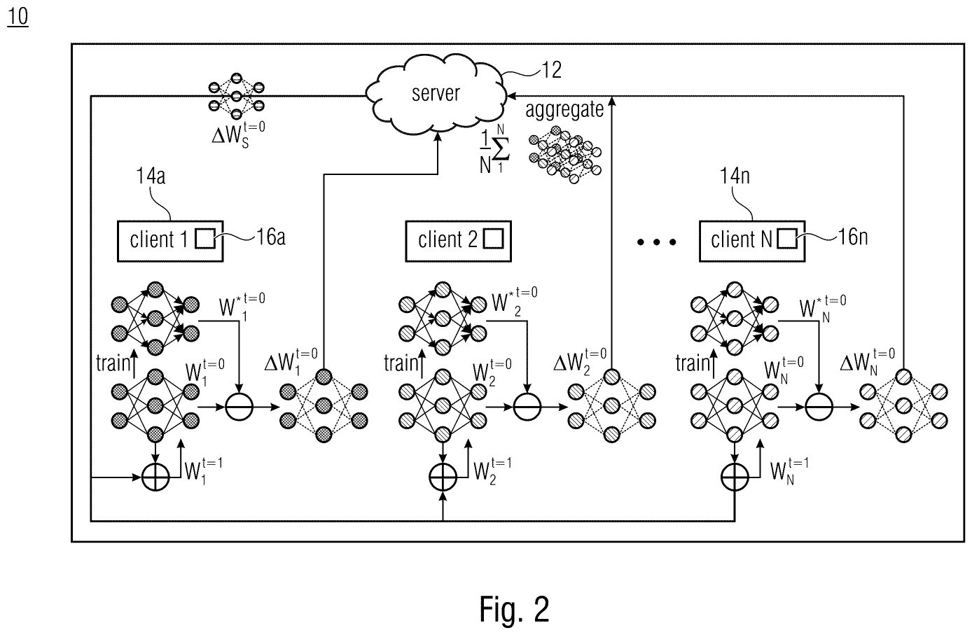

FIG. 2 shows a schematic view of a system for federated averaging learning 10, e.g., of a batch normalization neural network. In other words, FIG. 2 shows a federated averaging training paradigm.

The system 10 comprises a server 12 (or a plurality of servers 12) and N client devices (or clients) 14a-n, having data sets 16a-n.

The client devices 14 may comprise a user device such as a personal computer, mobile phone, tablet, or laptop. Alternatively or additionally, the client devices 14 may comprise other servers and/or cloud computing resources. The client devices 14 are configured to store and process neural networks, e.g., using one or more data storage devices and processors.

In the following, one of the N client devices 14a (in following referenced with reference number 14) will be described in more detail. However, it is noted that more than one (e.g., two, three, four, or more) or all client devices 14a-n may be configured to in the same or similar (e.g., differing in optional features) way, e.g., using a local and further parametrization, e.g., configured to perform the same method steps.

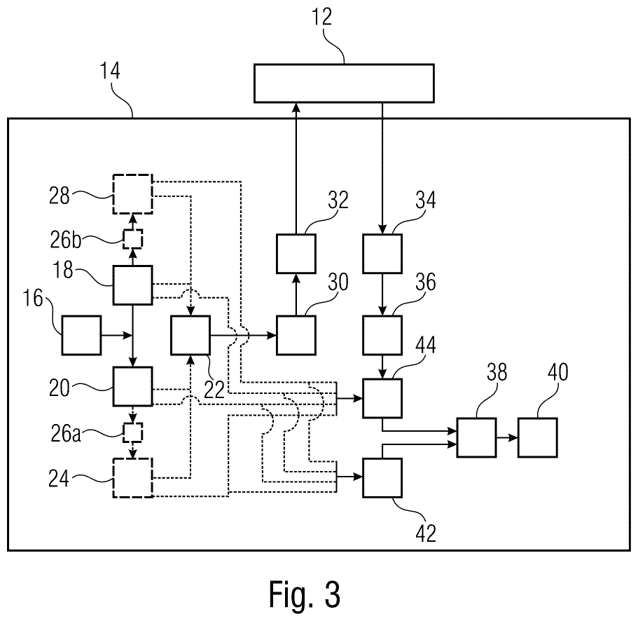

FIG. 3 shows a schematic view of a client device 14. The client device 14 can participate in federated learning of a neural network, e.g., that uses a server 12 and further client devices 14 as shown in FIG. 2.

The client device 14 is configured to perform, using a data set 16 (e.g., a training data set, e.g., a training data set exclusive to the client device 14) and starting from a current state 18

$$( e . g . , {W}_{1}^{t = 0} , {b}_{1}^{t = 0} , {μ}_{1}^{t = 0} , {σ}_{1}^{{2}^{t = 0}} , {γ}_{1}^{t = 0} , and {β}_{1}^{t = 0} in FIG . 2 )$$

of a parametrization (e.g., at least one of weights and hyper parameters) of the neural network, a training of the neural network to obtain an advanced state 20

$$( e . g . , {W}_{1}^{* t = 0} , {b}_{1}^{* t = 0} , {μ}_{1}^{* t = 0} , {σ}_{1}^{{2}^{* t = 0}} , {γ}_{1}^{* t = 0} , and {β}_{1}^{* t = 0} in FIG . 2 )$$

of the parametrization.

The client device 14 is further configured to compute a difference 22

$$( e . g . , Δ {\dot{W}}_{1}^{t = 0} , Δ {\dot{γ}}_{1}^{t = 0} , and Δ {\dot{β}}_{1}^{t = 0} in FIG . 2 )$$

between the advanced state 20

$$( e . g . , {W}_{1}^{* t = 0} , {b}_{1}^{* t = 0} , {μ}_{1}^{* t = 0} , {σ}_{1}^{{2}^{* t = 0}} , {γ}_{1}^{* t = 0} , and {β}_{1}^{* t = 0} in FIG . 2 )$$

of the parametrization or a re-parametrized-domain advanced state 24 (not shown in FIG. 2) of the parametrization derived from the advanced state 20 of the parametrization by means of a re-parametrization mapping 26a (e.g., using one or more convolution or folding functions) and the current state 18

$$( e . g . , {W}_{1}^{t = 0} , {b}_{1}^{t = 0} , {μ}_{1}^{t = 0} , {σ}_{1}^{{2}^{t = 0}} , {γ}_{1}^{t = 0} , and {β}_{1}^{t = 0} )$$

of a parametrization or a re-parametrized-domain current state 28 of the parametrization (e.g., using re-parametrization mapping 26b which may be identical or different from the re-parametrization mapping 26a) to obtain a local difference 30 (e.g., which may be identical to the difference 22 or be based on the difference 22).

The client device 14 is further configured to send a differential update 32 to the server 12, the differential update 32 comprising the local difference 30 and to receive an averaged update 34 from the server, the averaged update 34 comprising a received averaged difference 36.

The client device 14 is configured to update 38 the current state 18 of the parametrization to obtain an updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization using a local parametrization 42 obtained depending on one of the current state 18 of the parametrization, the re-parametrized-domain current state 28 of the parametrization, the advanced state 20 of the parametrization or the re-parametrized-domain advanced state 24 of the parametrization, and a further parametrization 44 obtained depending on the received averaged difference 36 and one of the current state 18 of the parametrization, the re-parametrized-domain current state 28 of the parametrization, the re-parametrized-domain advanced state 24 of the parametrization or the advanced state 20 of the parametrization.

The advanced state of a parameter may not necessarily be the updated version of the current state 18. In a non-federated learning scenario, in which a network is only trained on a single device, the advanced state of a parameter may usually be the updated version of a parameter. However, in federated learning, the updated version may be formed differently, for example, based on a sum of the current state and the received averaged difference. Therefore, the advanced state may be considered an intermediate state that may eventually be discarded or overwritten when the current state is updated. However, the updated version may occasionally be the updated version, e.g., in the case of the received averaged difference being zero.

In FIG. 3, the re-parametrized-domain advanced state 24 and the re-parametrized-domain current state 28 (as well as the re-parametrization mappings 26a, b) are shown with dashed lines, which indicate that one or both of the re-parametrized-domain current and advanced states 28, 24 may not necessarily be provided, e.g., if the current and/or advanced states 18, 20 of the parametrization is used instead. For example, if the difference 22 is computed between the advanced state 20 of the parameterization and the re-parametrized-domain current state 28 (or the current state 18 of the parametrization), the re-parametrized-domain advanced state 24 may not necessarily be provided (e.g., unless required for the update 38). Similarly, if the difference 22 is computed between the current state 18 of the parametrization and the advanced state 20 of the parameterization (or the re-parametrized-domain advanced state 24), the re-parametrized-domain current state 28 may not necessarily be provided (e.g., unless required for the update 38). The re-parametrization mapping 26a, b may comprise an identity for a portion of the parameters (or not perform a mapping), e.g., for weights (e.g., \dot{W}_{c}=W_{c}). The re-parametrization mapping 26a, b may map some of the parameters to a constant value (e.g., zero, one or a value close to one).

Furthermore, any one of the four states (i.e., current state 18 of the parametrization, advanced state 20 of the parametrization, re-parametrized-domain advanced state 24, and re-parametrized-domain current state 28) may be used to obtain the local parametrization 42 and of any one of the four states may be used to obtain the further parametrization 44. The state used to obtain the local parametrization 42 may (or may not) differ from the state used to obtain the further parametrization 44. For example, if the advanced state 20 of the parameterization is used for local parametrization 42, one of the other three states (e.g., one of current state 18 of the parametrization, re-parametrized-domain advanced state 24, or re-parametrized-domain current state 28) may be used to obtain the further parametrization 44 (e.g., using the re-parametrized-domain current state 28).

The difference 22 may be computed by using parameter states that are both in the re-parametrized domain (e.g., re-parametrized-domain current state 28 of the parametrization and re-parametrized-domain advanced state 24 of the parametrization) or both not in the re-parametrized-domain (e.g., current state 18 of the parametrization and advanced state 20 of the parametrization). Alternatively, only one of the parameters used for computing the difference 22 may be in the re-parametrized domain.

The current state 18 may be updated using states in the re-parametrized-domain and/or not in the re-parametrized-domain independent of whether (both or one of) the states used to compute a difference 22 are in the re-parametrized-domain. For example, the difference 22 may be computed using re-parametrized-domain advanced state 24 of the parametrization and re-parametrized-domain current state 28 of the parametrization (i.e., states in the re-parametrized-domain) and the update 38 of the current state 18 of the parametrization may be performed using the advanced state 20 of the parametrization (i.e., a state not in the re-parametrized-domain, e.g., in order to obtain the local parametrization 42).

In a federated learning scenario, as depicted in FIG. 2, the parameters of the client neural network layers (e.g., W_{c}, b_{c}, μ_{c}, σ_{c}², γ_{c}, and β_{c}) may be frequently updated using an aggregated difference update received from the server 12 (e.g., ΔWₛ, Δbₛ, Δμₛ, Δσₛ², Δγₛ, and Δβₛ). For example, in a synchronous base setting the client parameters are updated 38 by adding the received server update 34 (e.g., the aggregated difference update 36 comprised therein) to their current state 18, e.g., W_{c}==W_{c}+ΔWₛ. If clients are (partially) out of synch, they may, for example, resume training using their last local state 42, that was generated after the previous training

$${W}_{c} := {W}_{c}^{*}$$

The client devices 14 update the current state 18 of parametrization using the local parametrization 42 and the further parametrization 44. Since the further parametrization 44 depends on the received averaged difference 36 received from the server 12, the further parametrization 44 can be obtained based on training data of other client devices 14, which can be indicative of an overall training (due to federated learning). However, the use of the further parametrization 44 can bear potential risks, for example, in case of asynchronous timing (e.g., which can cause a drift of the parameters) or other issues (e.g., uneven training results due to heterogeneously distributed training data). The local parametrization 42 can be realized independent of the averaged difference 36, while being based on states of the client device 14 itself, which are more robust, e.g., in regards to asynchronous behaviour. Therefore, updating 38 the current state 18 can benefit from the robustness of the local parametrization 42 while also causing parameters to update according to further parametrization 44, which can overall improve training (e.g., with sufficient synchronicity).

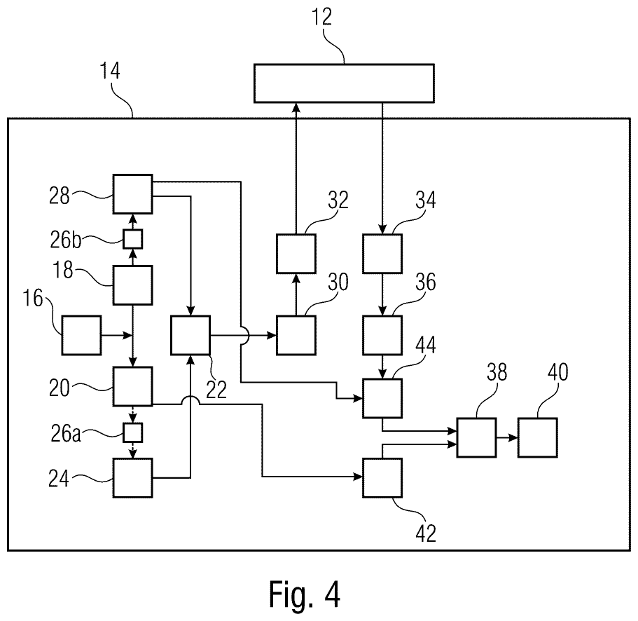

FIG. 4 shows an example of a client device 14 with a specific example of states for updating 38 the current state 18 of the parametrization. The example shows an example selection from the states depicted in FIG. 3.

In the example shown in FIG. 4, the client device 14 is configured to compute the difference 22

$$( e . g . , Δ {\dot{W}}_{1}^{t = 0} , Δ {\dot{γ}}_{1}^{t = 0} , and Δ {\dot{β}}_{1}^{t = 0} in FIG . 2 )$$

between the re-parametrized-domain advanced state 24 of the parametrization

$$( e . g . , {\dot{γ}}_{c}^{*} )$$

derived from the advanced state 20 of the parametrization by means of the re-parametrization mapping 26a and the re-parametrized-domain current state 28 of the parametrization (e.g., \dot{γ}_{c}) to obtain the local difference 30

$$( e . g . , Δ {\dot{γ}}_{c} = {\dot{γ}}_{c}^{*} - {\dot{γ}}_{c} ) .$$

As described above, the client device 14 is further configured to send a differential update 32 to the server 12, the differential update 32 comprising the local difference 30 and to receive an averaged update 34 from the server 12, the averaged update 34 comprising a received averaged difference 36 (e.g., Δ\dot{γ}ₛ). Any transmission disclosed herein, such as a transmission of the differential update 32 and/or the averaged update 34 may include transmission by wire and/or wireless transmission. Any transmission may comprise transmission by means of an internet connection. Any transmission may comprise transmission by means of a cellular network and/or a wireless local area network.

The client device 14 in the example of FIG. 4 is configured to update 38 the current state 18 of the parametrization to obtain the updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization using a local parametrization 42 obtained depending on the advanced state 20 of the parametrization (e.g., γ*_{c}) and the further parametrization 44 obtained depending on the received averaged difference 36 and the re-parametrized-domain current state 28 of the parametrization (e.g., \dot{γ}_{c}). For example, the updated state 40 for a parameter γ_{c} may be obtained based on the following equation 2:

$${γ}_{c} := ( 1 - η ) \cdot {γ}_{c}^{*} + η \cdot \sqrt{{σ}_{c}^{* 2} + ϵ} \cdot ( {\dot{γ}}_{c} + Δ \dot{{γ}_{s}} ) \qquad equation ( 2 )$$

wherein η is a weighting factor, γ*_{c} is the advanced state 20 of the parametrization, σ is an advanced state 20 of a standard deviation parameter, ϵ is a smaller scalar number (e.g., 0.001), \dot{γ}_{c} re-parametrized-domain current state 28 of the parametrization, and Δ\dot{γ}ₛ is received averaged difference 36.

However, the example shown in FIG. 4 and the equation 2 above is one of many ways to realise the client device 14 and to update 40 the current state of a parameter and serves as an example for a better understanding. In the following, generalizations, alternatives, and specifications are described, which may optionally be applicable to the example shown in FIG. 4.

According to an embodiment, the client device 14 may be configured to compute the further parametrization 44 using the received averaged difference 36 and the re-parametrized-domain current state 28 of the parametrization. The averaged difference 36 may be used linearly (e.g., to the power of one) and may, for example, be subjected to a scaling and/or offset function. The averaged difference 36 is received and therefore transmitted, making coding efficiency more relevant. By using both, the averaged difference 36 and the re-parametrized-domain current state 28, the re-parametrization can potentially be adapted to compensate modifications of the averaged difference 36 (e.g., a state that forms a basis for determining the averaged difference 36) in order to improve coding efficiency. For example, the averaged difference 36 may be determined based on parameters in the re-parametrized domain, e.g., in order to improve coding efficiency, wherein using the current state 28 in the re-parametrized-domain may improve a compatibility with the averaged difference 36.

According to an embodiment, the client device 14 may be configured to derive the local parametrization 42 from the advanced state 20 of the parametrization. The advanced state 20 of the parametrization may be used linearly (e.g., to the power of one) and may, for example, be subjected to a scaling and/or offset function. Since local parametrization 42 does not necessarily require transmission to the server 12, re-parametrization that improves, for example, coding efficiency may be omitted. Furthermore, the advanced state 20 of the parametrization may represent a better training progress compared to the current state 18 of the parametrization, which may improve the update 38 that depends on the local parametrization 42.

According to an embodiment, the client device 14 may be configured to compute the further parametrization 44 by correcting the re-parametrized-domain current state 28 of the parametrization using the received averaged difference 36 to obtain a corrected re-parametrized-domain state and subjecting the corrected re-parametrized-domain state to an affine transformation. The correction may comprise a (e.g., linear) summation of the re-parametrized-domain current state 28 of the parametrization and the received averaged difference 36. The affine transformation may include at least one of scaling factor (e.g., applied to the sum) and an (e.g., constant or variable) offset.

According to an embodiment, the client device 14 may be configured to update 38 the current state 18 of the parametrization using a weighted (e.g., linear) sum between the local parametrization 42 on the one hand and the further parametrization 44 on the other hand. The magnitude of the weights for the local parametrization 42 and the further parametrization 44 may be independent from each other or may be selected to complement to a sum of one. The weights essentially allow controlling how much the local parametrization 42 and the further parametrization 44 contribute to or influence the update 38 of the current state 18 of the parametrization. By selecting a larger weight for the local parametrization 42, the update is more robust to asynchronization and selecting a larger weight for the further parametrization 44 may result in a better training (e.g., as the further parametrization 44 is based on the received averaged difference 36, which may be more representative of a global federated learned training target).

According to an embodiment, the client device 14 may be configured to update 38 the current state 18 of the parametrization, for at least one parameter of the current state 18 of the parametrization, according to equation 3:

$${ρ}_{c} := ( 1 - η ) {ρ}_{c}^{l o c a l} + η ( B + ς ( {ρ}_{c}^{′ local} + Δ {ρ}_{s} ) ) \qquad equation ( 3 )$$

wherein
η is a weighting factor (e.g., between one and zero, e.g., between 0.4 and 0.6), B is an update shifting hyper parameter (e.g., which may be pre-demined and/or constant or variable) and [symbol] is an update scaling hyper parameter (e.g., which may be pre-demined and/or constant or variable).

$${ρ}_{c}^{l o c a l}$$

is the current state 18 or the parametrization or the advanced state 20 of the parametrization or depends on (e.g., using an affine transformation) the current state 18 of the parametrization and/or the advanced state 20 of the parametrization.

$${ρ}_{c}^{′ local}$$

is the current state 18 of the parametrization or the advanced state 20 of the parametrization or depends on (e.g., using an affine transformation) the current state 18 of the parametrization and/or the advanced state 20 of the parametrization, or the re-parametrized-domain current state 28 of the parametrization or the re-parametrized-domain advanced state 24 of the parametrization or depends on (e.g., using an affine transformation) the re-parametrized-domain current 28 state of the parametrization and/or the re-parametrized-domain advanced state 24 of the parametrization.
Δρₛ is the received averaged difference 36, and ρ_{c} is the updated state 40 of the parametrization.

The weighting factor η may be a fixed or pre-determined number or may be adaptable. For example, the weighting factor η may be adaptable based on at least one of a network traffic condition and a measure of asynchronicity between the client device 14 and the server 12. For example, if the network traffic conditions are indicative of a lower bandwidth (e.g., a lower amount of data transferable between client device 14 and server 12) and/or connection interruptions (e.g., a connection delay and/or interruption of a data connection exceeding a threshold), the weighting factor n may be lowered. As a result, the current state 18 of the parametrization or the advanced state 20 of the parametrization is weighted more and the received averaged difference 36 is weighted less. Therefore, the risk of a poorly updated state 40 of the parametrization (e.g., due to averaged difference 36 being received too late or not at all) may be reduced. Similarly, the weighting factor η may be increased if network traffic conditions are better (e.g., bandwidth exceeding a threshold) and/or connection interruptions are lower (e.g., an average of total or recent interruptions do not exceed a threshold).

For example, the weighing factor η∈[0, 1] may be a momentum hyperparameter to control an amount of local batch norm adaptation (e.g., using the local parametrization 42) and global batch norm information (e.g., using the further parametrization 44). The latter may increase global information sharing and may prevent client drift compared to the former term which emphasizes local batch norm statistics (adapted to the client's data), which in turn may be important for client model convergence. In practice, an η∈[0.1, 0.4] works well in a number of use cases. However, it can also be fine-tuned and be adapted per communication round.

In equation 3 above, the first weighted summand

$$( 1 - η ) {ρ}_{c}^{l o c a l}$$

may form the local parametrization 42 and the second weighted summand

$$η ( B + ϛ ( {ρ}_{c}^{′ local} + Δ {ρ}_{s} ) )$$

may form the further parametrization 44.

According to an embodiment, B is an update shifting hyper parameter and [symbol] is an update scaling hyper parameter that are to estimate a reversal of the re-parametrization mapping 26a, b with

$${ρ}_{c}^{′ local}$$

being the re-parametrized-domain advanced state 24 of the parametrization or depending on the re-parametrized-domain current state 28 of the parametrization and/or the re-parametrized-domain advanced state 24 of the parametrization. The update shifting hyper parameter B and the update scaling hyper parameter [symbol] may be (e.g., selected or determined) depending on similarity metrics or weight relevances (e.g., obtained from Layer-wise Relevance Propagation) obtained from a parametrization of the neural network (e.g., current state or re-parametrized-domain current state 28 or advanced state or re-parametrized-domain advanced state 24). Alternatively, the update shifting hyper parameter B and the update scaling hyper parameter [symbol] may be trained during the training of the neural network.

According to an embodiment, the client device 14 may be configured to subject the advanced state 20 of the parametrization to the re-parametrization mapping 26a to obtain the re-parametrized-domain advanced state 24

$$( e . g . , {W}_{1}^{* t = 0} , {\dot{b}}_{1}^{* t = 0} , {\dot{μ}}_{1}^{* t = 0} , {\dot{σ}}_{1}^{{2}^{* t = 0}} , {\dot{γ}}_{1}^{* t = 0} , and {\dot{β}}_{1}^{{*}^{t = 0}} )$$

of the parametrization. The client device 14 may further be configured to compute the local difference 30

$$( e . g . , Δ {W}_{1}^{t = 0} , Δ {\dot{γ}}_{1}^{t = 0} , and Δ {\dot{β}}_{1}^{t = 0} )$$

as a difference 22 between the re-parametrized-domain advanced state 24 of the parametrization and the re-parametrized-domain current 28 state of the parametrization. The client device 14 may further be configured to send the differential update 32 to the server 12 so that the differential update 32 comprises the re-parametrized-domain difference, and receive the averaged update 34 from the server 12 with the averaged update 34 comprising an averaged re-parametrized-domain difference.

The parametrization mapping 26a may improve a coding efficiency, e.g., by reducing the amount of parameters and/or spanning a more efficient domain. The client device 14 may be configured to, in subjecting the advanced state 20 of the parametrization to a batch normalization folding, use a parametrization mapping 26a which maps a first set of bias b, mean parameter μ, standard deviation parameter σ², trainable batch normalization scaling parameter γ and trainable batch normalization offset parameter β onto a second set of bias b, mean parameter μ, standard deviation parameter σ², trainable batch normalization scaling parameter γ and trainable batch normalization scaling parameter β according to

$$β := β + \frac{( b - μ ) * γ}{\sqrt{{σ}^{2} + ϵ}} \qquad equation ( 4 )$$

$$γ := γ \cdot \frac{\sqrt{θ + ϵ}}{\sqrt{{σ}^{2} + ϵ}} \qquad equation ( 5 )$$

with then setting

$${σ}^{2} := θ \qquad equation ( 6 )$$

$$μ := 0 \qquad equation ( 7 )$$

$$b := 0 \qquad equation ( 8 )$$

wherein θ is 1 or 1−ϵ.

Using a dot notation, the above equations may alternatively be defined as

$$\dot{β} := β + \frac{( b - μ ) * γ}{\sqrt{{σ}^{2} + ϵ}}$$

$$\dot{γ} := γ \cdot \frac{\sqrt{θ + ϵ}}{\sqrt{{σ}^{2} + ϵ}}$$

with then setting

$${\dot{σ}}^{2} = θ$$

$$\dot{μ} = 0$$

$$\dot{b} = 0$$

wherein θ is 1 or 1−ϵ.

This mapping allows reducing the amount of parameters, for which transmission (e.g., for the differential update 32 and the averaged update 34) may be required to two, e.g., β and γ. As a result, a required bandwidth for transmission can be reduced. In the present disclosure, examples of the invention are described using the above example mapping. Furthermore, the mapping 26a and 26b are treated as identical mappings. However, it is noted that other examples of mappings can be used as well. Furthermore, the mapping 26a and 26b may be different.

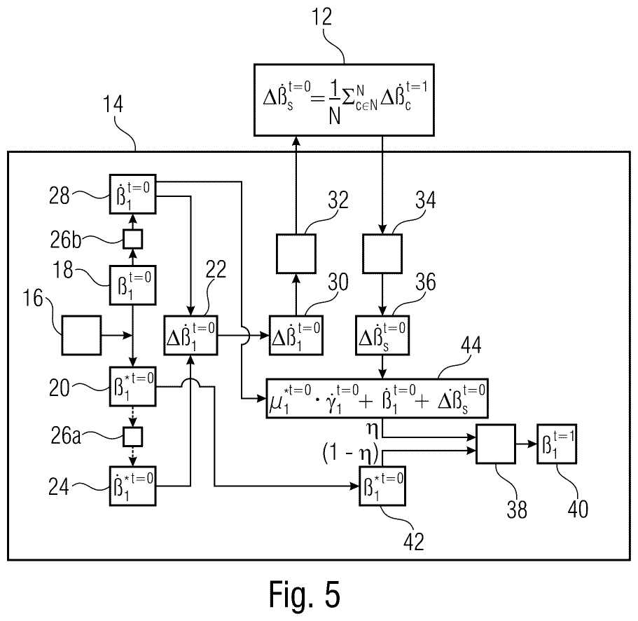

FIG. 5 shows an example of a client device 14 for updating 38 the current state 18 of the parametrization of an exemplary parameter β. For an easier understanding, FIG. 5 uses the example of states for updating 38 shown in FIG. 4. However, any other example of states may be used instead. Furthermore, the example is not limited to the parameter β and may be used with any other parameter (or any combination of a plurality of parameters).

Parameter β may be a trainable batch normalization scaling parameter, e.g., as described above with reference to equations 1 and 4. The client device 14 may be configured to repeat the steps of performing the training of the neural network, the subjecting to a re-parametrization mapping 26a, b, the computation of the difference 22, the sending, the receiving and the updating 38 in consecutive communication rounds, which may be defined herein with an index t, wherein t increases incrementally (e.g., t=0, 1, 2, 3, 4, . . . ). The current state 18 of the parametrization of a first client device 14 (from N client devices that are indexed by the index c, wherein the first client device 14 has the index c=1) in a first round (t=0) is in the following exemplarily denoted as

$${β}_{1}^{t = 0} .$$

Furthermore, an advanced state 20 of the parametrization is denoted by an asterisk (*). For example, an advanced state 20 of the parametrization for the parameter β in the first communication round (t=0) is herein denoted as

$${β}_{1}^{* t = 0} .$$

A re-parametrized-domain state of a parameter is herein denoted with a dot (e.g.,

$${\dot{β}}_{1}^{t = 0}$$

for a re-parametrized-domain current state 28 of the parameter β during the first communication round).

According to an embodiment, the client device 14 may be configured to update 38

$$( e . g . , {β}_{1}^{t = 1} , )$$

the current state 18 of the parametrization with respect to at least one parameter (e.g.,

$${β}_{1}^{t = 0} ,$$

e.g., all parameter) of the current state 18 of the parametrization, performing a weighted summation (e.g., weighted by (1−η) and η, respectively) between a corresponding parameter

$$( e . g . , {β}_{1}^{* t = 0} )$$

of the advanced state 20 of the parametrization, on the one hand, and an estimated state update

$$( c . p . {μ}_{c}^{*} \cdot {\dot{γ}}_{c} + {β}_{c} , e . g . , {μ}_{c}^{*} \cdot {γ}_{c} + {β}_{c , u}^{t = 0} ,$$

with an updated re-parametrized-domain state of the parametrization

$${\dot{β}}_{c , u}^{t = 0} = {\dot{β}}_{c}^{t = 0} + Δ {\dot{β}}_{s} )$$

for a corresponding parameter of the current state 18 of the parametrization obtained by means of an updated re-parametrized-domain state of the parametrization

$$( e . g . , {\dot{β}}_{c , u}^{t = 0} = {\dot{β}}_{c}^{t = 0} + Δ {\dot{β}}_{s} )$$

derived from the received averaged re-parametrized-domain difference (e.g., Δ\dot{β}ₛ) and the re-parametrized-domain current state 28 of the parametrization

$$( e . g . , {\dot{β}}_{c}^{t = 0} ) ,$$

on the other hand. For example, the client device 14 may be configured to determine the estimated state update

$$( c . p . {μ}_{c}^{*} \cdot {\dot{γ}}_{c} + {\dot{β}}_{c} , e . g . , the term {μ}_{c}^{*} \cdot {γ}_{c} + {β}_{c , u}^{t = 0} )$$

for the corresponding parameter of the current state 18 of the parametrization by subjecting the updated re-parametrized-domain state

$$( e . g . , {\dot{β}}_{c , u}^{t = 0} )$$

or the parametrization to an affine transformation (c.p. B+ [symbol] (ρ_{c}+Δρₛ), e.g., with Δρₛ=Δ\dot{β}ₛ,

$${ρ}_{c} = {\dot{β}}_{c}^{t = 0} ,$$

[symbol]

=1 or in a range of 0.41 to 1.5, e.g., 0.1 to 1, and B=0, or B as a update shifting hyperparameter, or as

$$B = {μ}_{c}^{* t = 0} \cdot {\dot{γ}}_{c}^{t = 0} ) .$$

For example, the estimated state update may be determined as

$${μ}_{1}^{* t = 0} \cdot {\dot{γ}}_{1}^{t = 0} + {\dot{β}}_{1}^{t = 0} + Δ {\dot{β}}_{s}^{t = 0}$$

for a trainable batch normalization offset parameter β and/or as

$$\sqrt{{( {σ}_{1}^{* t = 0} )}^{2} + ϵ} \cdot ( {\dot{γ}}_{1}^{t = 0} + {\dot{Δγ}}_{s}^{t = 0} )$$

for trainable batch normalization scaling parameter γ.

According to an embodiment, the client device 14 may be configured to perform the training of the neural network by using a gradient descent algorithm (e.g., minimizing a loss function) to optimize weights of the current state 18 of the parametrization

$$( e . g . , {W}_{1}^{t = 0} ) ,$$

a bias of the current state of the parametrization

$$( e . g . , {b}_{1}^{t = 0} ) ,$$

and at least one parameter (e.g.,

$${β}_{1}^{t = 0} ,$$

e.g., all parameter) of the current state 18 of the parametrization. For example, the gradient descent algorithm may use a loss function that minimizes a gradient of at least one of the weights, bias and the at least one parameter.

According to an embodiment, the client device 14 may be configured to, in computing the difference 22

$$( e . g . , Δ {W}_{1}^{t = 0} , Δ {\dot{γ}}_{1}^{t = 0} , and Δ {\dot{β}}_{1}^{t = 0} )$$

between the re-parametrized-domain advanced state 24 of the parametrization

$$( e . g . , {\dot{β}}_{1}^{* t = 0} )$$

and the re-parametrized-domain current state 28 of the parametrization

$$( e . g . , {β}_{1}^{* t = 0} ) ,$$

compute differences 22 between weights of the re-parametrized-domain advanced state 24 of the parametrization and the re-parametrized-domain current state 28 of the parametrization

$$( e . g . , Δ {W}_{1}^{t = 0} = {\dot{W}}_{1}^{* , t = 0} - {\dot{W}}_{1}^{t = 0} )$$

and between a re-parametrized-domain parameter of the re-parametrized-domain advanced state 24 of the parametrization and the re-parametrized-domain current state 28 of the parametrization

$$( e . g . , {Δβ}_{1}^{t = 0} = {\dot{β}}_{1}^{* t = 0} - {\dot{β}}_{1}^{t = 0} ) , e . g . , {Δγ}_{1}^{t = 0} = {\dot{γ}}_{1}^{* t = 0} - {\dot{γ}}_{1}^{t = 0} ) .$$

By forming the difference 22 between states in the re-parametrized domain, the difference may be formed in a domain that is more efficient for coding (e.g., due to a lower number of parameters and/or a more efficient value range of parameters). Therefore, transmission of the difference 22 to the server may entail less bandwidth.

According to an embodiment, the client device 14 may be configured to repeat the steps of performing the training of the neural network, the subjecting to a re-parametrization mapping 26a, b, the computation of the difference 22, the sending, the receiving and the updating 38 in consecutive communication rounds (e.g., rounds t=1, 2, 3, 4 and so on), wherein the current state 18 of the parametrization for a subsequent communication round (e.g., t=1) is defined by the updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization for a current communication round (e.g., t=0), and wherein the re-parametrized-domain current state 28

$$( e . g . , {\dot{W}}_{1}^{t = 1} , {\dot{b}}_{1}^{t = 1} , {\dot{μ}}_{1}^{t = 1} , {\dot{σ}}_{1}^{{2}^{t = 1}} , {\dot{γ}}_{1}^{t = 1} , and {\dot{β}}_{1}^{t = 1} )$$

of the parametrization for a subsequent communication round (e.g., t=1) is defined by an updated re-parametrized-domain state of the parametrization for the current communication round

$$( e . g . , {\dot{β}}_{c , u}^{t = 0} ) ,$$

which is computed in the current communication round by use of (e.g., a sum or weighted sum of) the received averaged re-parametrized-domain difference (e.g., Δ\dot{β}ₛ) and the re-parametrized-domain current state 28 of the parametrization for the current communication round

$$( e . g . , {\dot{β}}_{c , u}^{t = 0} = {\dot{β}}_{c}^{t = 0} + Δ {\dot{β}}_{s} , e . g . , {\dot{γ}}_{c}^{t = 0} = {\dot{γ}}_{c}^{t = 0} + Δ {\dot{γ}}_{s} ) .$$

The received averaged re-parametrized-domain difference may form a learning progress determined from the plurality of client device 14, which is determined in the re-parametrized-domain state. Determining the updated re-parametrized-domain state of the parametrization based on values re-parametrized-domain, reduces the risk of errors caused by different parameter domains and enables determining and transmission of the updated re-parametrized-domain state in a parameter-domain that may be adapted to be coding efficient. The client device 14 may be configured to repeat the steps above, until a criterion (e.g., related to an amount of rounds and/or the difference 22) is fulfilled (e.g., a pre-determined amount of rounds have been performed and/or the difference 22 is smaller than a pre-determined threshold) and/or a signal is received (e.g., from the server 12) that indicates a stop or pause of the repetition.

According to an embodiment, the client device 14 may be configured to, in sending the differential update 32 to the server 12, and/or receiving the averaged update 34 from the server 12, use a syntax element (e.g., one or more flags, e.g., one or more indices) indicative of a use of a re-parametrized-domain for transmission. The syntax element may be indicative of whether a re-parametrized mapping 26a, b is used (e.g., a binary flag). Alternately or additionally, the syntax element may be indicative of the re-parametrization mapping 26a, b. For example, the syntax element may be indicative (or be formed by) an index that indexes a list of re-parametrization mappings. Alternatively or additionally, the syntax element may be indicative of functions and/or function parameters of the re-parametrization mapping. As a result, the client device 14 (or an encoder thereof) may be able to adapt the re-parametrization mapping (e.g., in case a mapping may improve coding efficiency) and/or confirm that a mapping has been used (e.g., in the case the server 12 instructs one or more of the client devices 14 to use a specific mapping).

According to an embodiment, the client device 14 may be configured to use the received averaged re-parametrized-domain difference (e.g., Δ\dot{β}ₛ) to update the re-parametrized-domain current state 28 of the parametrization

$$( e . g . , {\dot{β}}_{c , u}^{t = 0} = {\dot{β}}_{c}^{t = 0} + Δ {\dot{β}}_{s} ) ,$$

and in updating 38 the current state 18 of the parametrization to obtain an updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization, determine the estimated state update

$$( c . p . {μ}_{c}^{*} \cdot {\dot{γ}}_{c} + {\dot{β}}_{c} , e . g . , {μ}_{c}^{*} \cdot {\dot{γ}}_{c} + {\dot{β}}_{c , u}^{t = 0} )$$

for the corresponding parameter of the current state 18 of the parametrization obtained by subjecting the updated re-parametrized-domain state of the parametrization to an affine transformation (c.p. B+ [symbol] (ρ_{c}+Δρₛ), e.g., with Δρₛ=Δβs,

$${ρ}_{c} = {\dot{β}}_{c}^{t = 0} ,$$

[symbol]

=1 or in a range of 0.1 to 1.5, e.g., 0.1 to 1, and B=0, or B as a update shifting hyperparameter, or as

$$B = {μ}_{c}^{* t = 0} \cdot {\dot{γ}}_{c}^{t = 0} ) .$$

According to an embodiment, the client device 14 may be configured to derive the updated re-parametrized-domain state of the parametrization

$$( e . g . , {\dot{β}}_{c , u}^{t = 0} )$$

by a summation of the received averaged re-parametrized-domain difference and the re-parametrized-domain current state 28 of the parametrization. For example, the updated re-parametrized-domain state of the parametrization P may be derived for using the following equation 9:

$${\dot{β}}_{c , u}^{t = 0} = {\dot{β}}_{c}^{t = 0} + Δ {\dot{β}}_{s}^{t = 0} \qquad equation ( 9 )$$

It is noted that a different version of equation 9 is cited further below using a shortened version as

$${\dot{β}}_{c} := {\dot{β}}_{c} + Δ {\dot{β}}_{s} ,$$

wherein a double-dot-equal-sign (“:=”) indicates a definition or rather a re-definition for a subsequent or new communication round (e.g., in the sense of an iterative algorithm).

Furthermore, it is noted that for some parametrization mapping such as the one disclosed herein, \dot{γ}_{c} and \dot{β}_{c} may be identical to \dot{γ}ₛ and \dot{β}ₛ for some or all client devices 14 (or c), since the server 12 may provide all clients 14 with an identical set of initial parameters and thus the untrained parameters (without the superscript “*”) may remain in sync by adding identical server updates in each communication round.

As shown in FIG. 5, the updated state 40 of the parametrization for β (and client device c=1) may be defined by the following equation 10:

$${β}_{1}^{t = 1} = ( 1 - η ) \cdot {β}_{1}^{* t = 0} + η \cdot ( {μ}_{1}^{* t = 0} \cdot {\dot{γ}}_{1}^{t = 0} + {\dot{β}}_{c , u}^{t = 0} ) \qquad equation ( 10 )$$

or as an iterative version defining a parameter of a new communication round:

$${β}_{c} := ( 1 - η ) \cdot {β}_{c}^{*} + η \cdot ( {μ}_{c}^{*} \cdot {\dot{γ}}_{c} + {\dot{β}}_{c} )$$

with \dot{β}_{c}:=\dot{β}_{c}+Δ\dot{β}ₛ.

It is noted that the summand

$${μ}_{1}^{* t = 0} \cdot {\dot{γ}}_{1}^{t = 0}$$

is specific to the present example of the parametrization mapping. More generally, the right summand of equation 10 (that is weighted by η) may comprise a reverse-mapping (e.g., using one or more convolution or folding functions) that maps the updated re-parametrized-domain state of the parametrization

$$( e . g . , {\dot{β}}_{c , u}^{t = 0} )$$

back to a reverse-parametrized-domain (e.g., which may fully or partly reverse the re-parametrization mapping 26a, b).

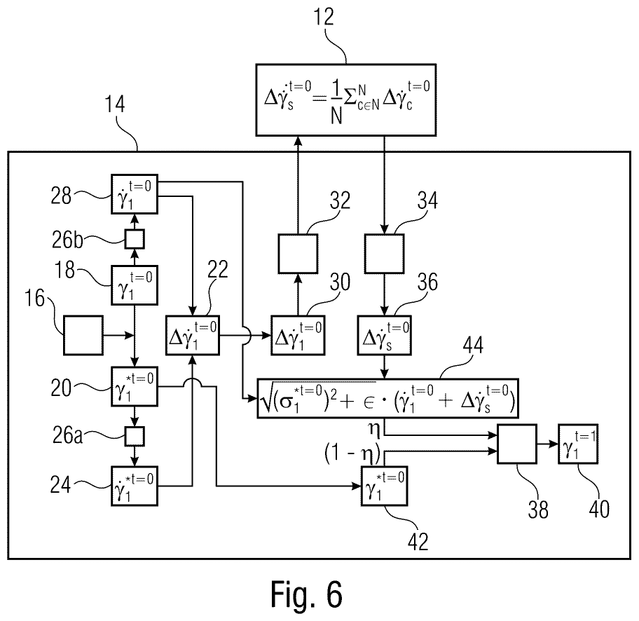

FIG. 6 shows another example of a client device 14 for updating 38 the current state 18 of the parametrization of an exemplary parameter γ. For an easier understanding, FIG. 6 uses the example of states (in regards to current, advanced, and re-parametrization domain) for updating 38 shown in FIGS. 4 and 5. However, any other example of states (e.g., for each parameter individually or collective for a group of parameters) may be used instead. Furthermore, the example is not limited to the parameter γ (or any other parameter such as β) and may be used alone or with any other parameter (or with any combination of a plurality of parameters).

In the following, an example of client device 14 is described that uses a trainable batch normalization offset parameter β and a trainable batch normalization scaling parameter γ and re-parametrized versions thereof. The example shows how a parameter mapping (e.g., using folding) for multiple parameters (as described above in equations 4 to 8) may be used for updating the current state 18 of the parametrization. However, it is noted that the client device 14 is not limited thereto. For example, any other parameter, number of parameters, parametrization mapping, and selection of states may be used.

The example client device 14 mostly references FIG. 5 for parameter β and FIG. 6 for γ, but is not limited thereto.

According to an embodiment, the neural network (e.g., of the client device 14) is a batch normalization neural network (e.g., as defined in equation 1 above), the re-parametrization mapping 26a, b is a batch normalization folding, the re-parametrized-domain advanced state 24 of the parametrization being equivalent, in terms of inference result, to the advanced state 20 of the parametrization (e.g., the same set of inputs may result in the same inference, e.g., inference result, e.g., regardless of whether the parameters are in the re-parametrized domain or not).

The computation of a difference 22

$$( e . g . , Δ {W}_{1}^{t = 0} , Δ {\dot{γ}}_{1}^{t = 0} , and Δ {\dot{β}}_{1}^{t = 0} )$$

between the re-parametrized-domain advanced state 24 of the parametrization and a re-parametrized-domain current state 28 of the parametrization may yield a weight difference

$$( e . g . , Δ {W}_{1}^{t = 0} ) ,$$

a re-parametrized-domain trainable batch normalization offset parameter difference

$$( e . g . , Δ {\dot{β}}_{1}^{t = 0} )$$

and a re-parametrized-domain trainable batch normalization scaling parameter difference

$$( e . g Δ {\dot{γ}}_{1}^{t = 0} ) .$$

The differential update 32 may comprise the weight difference

$$( e . g . , Δ {W}_{1}^{t = 0} ) ,$$

the re-parametrized-domain trainable batch normalization offset parameter difference

$$( e . g . , Δ {\dot{β}}_{1}^{t = 0} )$$

and the re-parametrized-domain trainable batch normalization scaling parameter difference

$$( e . g Δ {\dot{γ}}_{1}^{t = 0} ) .$$

Alternatively, the differential update 32 may comprise only one or some of the differences 22. Differences 22 for a bias b, a mean parameter μ, and a standard deviation parameter σ² may not necessarily be computed and/or sent (e.g., enabled by a corresponding re-parametrization mapping).

The averaged update 34 may comprise a received averaged weight difference

$$( e . g . , Δ {W}_{s}^{t = 0} ) ,$$

a received averaged re-parametrized-domain trainable batch normalization offset parameter difference

$$( e . g . , Δ {\dot{β}}_{s}^{t = 0} )$$

and a received averaged re-parametrized-domain trainable batch normalization scaling parameter difference

$$( e . g . , Δ {\dot{γ}}_{s}^{t = 0} ) .$$

One or more (or all) of the averaged differences may be determined (e.g., by the server 12) based on (or as) a sum of the differences of a parameter of some or all (e.g., N) client devices 14 and divided by an amount of summed up differences (e.g., divided by N if the differences of all N client devices 14 is used). For example, the averaged re-parametrized-domain trainable batch normalization scaling parameter difference

$$( e . g . , Δ {\dot{γ}}_{s}^{t = 0} )$$

may be determined by the following equation 11:

$$Δ {\dot{γ}}_{s}^{t = 0} = \frac{1}{N} {\sum }_{c ∈ N}^{N} Δ {\dot{γ}}_{c}^{t = 0} \qquad equation ( 11 )$$

The updating 38 of the current state 18 of the parametrization to obtain the updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization ma involve, with respect to a trainable batch normalization offset parameter (e.g.,

$${β}_{1}^{t = 0} ,$$

e.g., see FIG. 5) of the current state 18 of the parametrization, performing a weighted summation (e.g., using weight η and 1−η) between a trainable batch normalization offset parameter (e.g.

$${β}_{1}^{* t = 0}$$

in the example of FIG. 5) of the advanced state 20 of the parametrization, on the one hand, and an estimated state update

$$( c . p . {μ}_{c}^{*} \cdot {\dot{γ}}_{c} + {\dot{β}}_{c} , e . g . , {μ}_{1}^{* t = 0} \cdot {\dot{γ}}_{1}^{* t = 0} + {\dot{β}}_{c , u}^{* t = 0} , \text{} e . g . , {μ}_{1}^{* t = 0} \cdot {\dot{γ}}_{1}^{* t = 0} + {\dot{β}}_{1}^{* t = 0} + Δ {\dot{β}}_{s}^{t = 0} as shown in FIG . 5 )$$

for a trainable batch normalization offset parameter of the current state 18 of the parametrization obtained by means of the received averaged re-parametrized-domain trainable batch normalization offset parameter difference

$$( e . g . , Δ {\dot{β}}_{s}^{t = 0} ) .$$

Furthermore, the steps of updating 38 the current state 18 of the parametrization to obtain the updated state 40 may involve, with respect to a trainable batch normalization scaling parameter (e.g.,

$${γ}_{1}^{t = 0} ,$$

see FIG. 6) of the current state 18 of the parametrization,
performing a weighted summation (e.g., using weights η and 1−η) between a trainable batch normalization scaling parameter

$$( e . g . , {γ}_{1}^{* t = 0} )$$

of the advanced state 20 of the parametrization, on the one hand, and an estimated state update

$$( c . p . \sqrt{{σ}_{c}^{* 2} + ϵ} \cdot {\dot{γ}}_{c} , e . g . , \sqrt{{( {σ}_{1}^{* t = 0} )}^{2} + ϵ} \cdot ( {\dot{γ}}_{1}^{t = 0} + {\dot{Δγ}}_{s}^{t = 0} ) )$$

for a trainable batch normalization scaling parameter of the current state 18 of the parametrization obtained by means of the received averaged re-parametrized-domain trainable batch normalization scaling parameter difference

$$( e . g . , {\dot{Δγ}}_{s}^{t = 0} ) ,$$

on the other hand.

According to an embodiment, the client device 14 may be configured to update 38 the current state 18 of the parametrization to obtain the updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization by updating (c.p. W_{c}:=W_{c}+ΔWₛ) weights

$$( e . g . , {W}_{1}^{t = 0} )$$

of the current state 18 of the parametrization using the averaged weight difference.

The client device 14 may be configured to update the weights

$$( e . g . , {W}_{1}^{t = 0} )$$

of the current state 18 of the parametrization using the averaged weight difference by computing a sum of the weights

$$( e . g . , {W}_{1}^{t = 0} )$$

of the current state 18 of the parametrization and the averaged weight difference. In one example, no parametrization mapping (or a parametrization mapping with an identity) may be applied to the weights. Alternatively, a parametrization mapping (e.g., comprising at least one non-identity) may be applied to the weights. In such a case, the updating may or may not be performed similarly as described herein in regards to trainable batch normalization offset parameter β and/or the trainable batch normalization scaling parameter γ.

According to an embodiment, the client device 14 may be configured to update 38 the current state 18 of the parametrization to obtain the updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization by computing an updated re-parametrized-domain trainable batch normalization offset parameter

$$( c . p . {\dot{β}}_{c} := {\dot{β}}_{c} + Δ {\dot{β}}_{s} , e . g . , {\dot{β}}_{c , u}^{t = 0} = {\dot{β}}_{1}^{t = 0} + Δ {\dot{β}}_{s}^{t = 0} as shown in FIG . 5 )$$

and an updated re-parametrized-domain trainable batch normalization scaling parameter

$$( c . p . {\dot{γ}}_{c} := {\dot{γ}}_{c} + Δ {\dot{γ}}_{s} , e . g . , {\dot{γ}}_{c , u}^{t = 0} = {\dot{γ}}_{c}^{t = 0} + {\dot{Δγ}}_{s}^{t = 0} )$$

by use of the received averaged re-parametrized-domain trainable batch normalization offset parameter difference

$$( e . g . , Δ \dot{{β}_{s}} , e . g . , Δ {\dot{β}}_{s}^{t = 0} ) ,$$

the received averaged re-parametrized-domain trainable batch normalization scaling parameter difference

$$( e . g . , Δ \dot{{γ}_{s}} , e . g . , Δ {\dot{γ}}_{s}^{t = 0} )$$

and a re-parametrized-domain trainable batch normalization offset parameter

$$( e . g . , {\dot{β}}_{1}^{t = 0} )$$

and a re-parametrized-domain trainable batch normalization scaling parameter

$$( e . g . , {\dot{γ}}_{c}^{t = 0} )$$

of the current state 18 of the parametrization. The client device 14 may be configured to update 38 the current state 18 of the parametrization by computing the estimated state update

$$( c . p . {μ}_{c}^{*} \cdot {\dot{γ}}_{c} + {\dot{β}}_{c} , e . g . , {μ}_{1}^{* t = 0} \cdot {\dot{γ}}_{1}^{t = 0} + {\dot{β}}_{1}^{t = 0} + Δ {\dot{β}}_{s}^{t = 0} )$$

for the trainable batch normalization offset parameter of the current state 18 of the parametrization and the estimated state update for the trainable batch normalization scaling parameter

$$( c . p . \sqrt{{σ}_{c}^{* 2} + ϵ} . {\dot{γ}}_{c} , e . g . , \sqrt{{( {σ}_{1}^{* t = 0} )}^{2} + ϵ} \cdot ( {\dot{γ}}_{1}^{t = 0} + \dot{Δ} {γ}_{s}^{t = 0} ) )$$

of the current state 18 of the parametrization based on the updated re-parametrized-domain trainable batch normalization offset parameter

$$( c . p . {\dot{β}}_{c} := \dot{{β}_{c}} + Δ \dot{{β}_{s}} , e . g . , {\dot{β}}_{c , u}^{t = 0} = {\dot{β}}_{1}^{t = 0} + Δ {\dot{β}}_{s}^{t = 0} )$$

and the updated re-parametrized-domain trainable batch normalization scaling parameter

$$( c . p . {\dot{γ}}_{c} := \dot{{γ}_{c}} + Δ \dot{{γ}_{s}} , e . g . , {\dot{γ}}_{c , u}^{t = 0} = {\dot{γ}}_{c}^{t = 0} + Δ {\dot{γ}}_{s}^{t = 0} ) ,$$

and on-trainable statistical batch normalization parameters of the advanced state 20 of the parametrization (c.p.

$${μ}_{c}^{*} , {σ}_{c}^{* 2} ,$$

e.g., advanced states of a mean parameter and a standard deviation parameter).

The client device 14 may be configured to update 38 the current state 18 of the parametrization by updating 38 a trainable batch normalization offset parameter

$$( e . g . , {β}_{1}^{t = 0} )$$

of the current state 18 of the parametrization using a first weighted sum

$$( c . p . {β}_{c} := ( 1 - η ) \cdot {β}_{c}^{*} + η \cdot ( {μ}_{c}^{*} \cdot {\dot{γ}}_{c} + {\dot{β}}_{c} ) )$$

of the trainable batch normalization offset parameter

$$( e . g . , {β}_{1}^{* t = 0} )$$

of the advanced state 20 of the parametrization, and the estimated state update for the trainable batch normalization offset parameter

$$( e . g . , {μ}_{1}^{* t = 0} \cdot {\dot{γ}}_{1}^{t = 0} + {\dot{β}}_{c , u}^{t = 0} ) ,$$

and a trainable batch normalization scaling parameter

$$( e . g . , {γ}_{1}^{t = 0} )$$

of the current state 18 of the parametrization using a second weighted sum

$$( c . p . {γ}_{c} := ( 1 - η ) \cdot {γ}_{c}^{*} + η \cdot \sqrt{{σ}_{c}^{* 2} + ϵ} \cdot {\dot{γ}}_{c} )$$

of the trainable batch normalization scaling parameter

$$( e . g . , {γ}_{1}^{* t = 0} )$$

of the advanced state 20 of the parametrization and the estimated state update for the trainable batch normalization scaling parameter.

According to an embodiment, the client device 14 may be configured so that, in the first weighted sum (c.p. β_{c}:=(1−η)·β*_{c}+η·(μ*_{c}·\dot{γ}_{c}+\dot{β}_{c})), the trainable batch normalization offset parameter

$$( e . g . , {β}_{1}^{{* t = 0}^{}} )$$

of the advanced state 20 of the parametrization forms a first summand which is weighted by a first factor and the estimated state update for the trainable batch normalization offset parameter forms a second summand which is weighted by a second factor, and in the second weighted sum

$$( c . p . {γ}_{c} := ( 1 - η ) \cdot {γ}_{c}^{*} + η \cdot \sqrt{{σ}_{c}^{* 2} + ϵ} \cdot {\dot{γ}}_{c} ) ,$$

the trainable batch normalization scaling parameter

$$( e . g . , {γ}_{1}^{* t = 0} )$$

of the advanced state 20 of the parametrization forms a third summand which is weighted by the first factor and the estimated state update for the trainable batch normalization scaling parameter forms a fourth summand which is weighted by the second factor.

For example, the client device 14 may be configured to update 38 the current state 18 of the parametrization by updating 38 a trainable batch normalization offset parameter

$$( e . g . , {β}_{1}^{t = 0} )$$

of the current state 18 of the parametrization using equation 10 above and the trainable batch normalization scaling parameter

$$( e . g . , {γ}_{1}^{t = 0} )$$

of the current state 18 of the parametrization using the following equation 12:

$${γ}_{1}^{t = 1} := ( 1 - η ) \cdot {γ}_{1}^{* t = 0} + η \cdot \sqrt{{( {σ}_{1}^{* t = 0} )}^{2} + ϵ} \cdot ( {\dot{γ}}_{1}^{t = 0} + {\dot{Δγ}}_{s}^{t = 0} ) \qquad equation ( 12 )$$

or according to equation 2 (e.g., comprising an iterative notation using “:=”).

According to an embodiment, the client device 14 may be configured so that the first and second factors sum-up to 1 (e.g., with factors or summation weights η and 1−η that add up to η+1−η=1). Alternatively, the factors may sum up to a different value.

According to an embodiment, the client device 14 may be configured so that the first and second factors are fixed by default (e.g., being known to the client device 14 without requiring communication values of the factors from the server 12) or the client device 12 is configured to determine same from a corresponding message from the server 12 (e.g., signalled together or within a message that signals the averaged update 34). The message may comprise the value for at least one of the factors or an index that allows determining the factors.

According to an embodiment, the client device 14 may be configured so that the second factor is within interval [0.1, 0.4].

According to an embodiment, the client device 14 may be configured to compute the estimated state update for the trainable batch normalization scaling parameter

$$( c . p . \sqrt{{σ}_{c}^{* 2} + ϵ} \cdot {\dot{γ}}_{c} )$$

of the current state 18 of the parametrization based on the updated re-parametrized-domain trainable batch normalization scaling parameter (c.p. \dot{γ}_{c}), and a standard deviation parameter of the non-trainable statistical batch normalization parameters of the advanced state 20 of the parametrization

$$( c . p . {σ}_{c}^{* 2} ) ,$$

and the estimated state update

$$( c . p . {μ}_{c}^{*} \cdot {\dot{γ}}_{c} + {\dot{β}}_{c} )$$

for the trainable batch normalization offset parameter of the current state 18 of the parametrization based on the updated re-parametrized-domain trainable batch normalization offset parameter (c.p. \dot{β}_{c}), the updated re-parametrized-domain trainable batch normalization scaling parameter (c.p. \dot{γ}_{c}), and a mean parameter of the non-trainable statistical batch normalization parameters of the advanced state 20 of the parametrization

$$( c . p . {μ}_{c}^{*} ) .$$

Such a computation may be realized by the equations 10 and 12 above.

According to an embodiment, the client device 14 may be configured to update 38 the current state 18 of the parametrization to obtain the updated state 40 of the parametrization by adopting

$$( c . p . {μ}_{c} := {μ}_{c}^{*} and {σ}_{c}^{2} := {μ}_{c}^{{*}^{2}} , e . g . , {μ}_{1}^{t = 1} = {μ}_{1}^{* t = 0} , e . g . , {σ}_{1}^{t = 1} = {σ}_{1}^{* t = 0} )$$

non-trainable statistical batch normalization parameters of the advanced state 20 of the parametrization as non-trainable statistical batch normalization parameters of the updated state 40 of the parametrization. In other words, the client device 14 may be configured to update 40 some of the parameters (e.g., nontrainable statistical batch normalization parameters) without requiring receiving differences 22 for said parameters. As a result, an amount of data to be transmitted can be reduced.

According to an embodiment, the client device 14 may be configured to perform the training of the batch normalization neural network by using a gradient descent algorithm to optimize weights of the current state 18 of the parametrization

$$( e . g . , {W}_{1}^{t = 0} ) ,$$

a bias of the current state 18 of the parametrization

$$( e . g . , {b}_{1}^{t = 0} ) ,$$

the trainable batch normalization offset parameter

$$( e . g . , {β}_{1}^{t = 0} )$$

of the current state 18 of the parametrization, and the trainable batch normalization scaling parameter

$$( e . g . , {γ}_{1}^{t = 0} )$$

of the current state 18 of the parametrization. For example, the gradient descent algorithm may use a loss function that minimizes a gradient of at least one of the weights, bias the trainable batch normalization offset parameter, and the trainable batch normalization scaling parameter.

According to an embodiment, the client device 14 may be configured to, in performing the training of the batch normalization neural network, compute non-trainable statistical batch normalization parameters of the advanced state 20 of the parametrization, perform a mean and variance computation on hidden activations of the batch normalization neural network encountered when using the data set 16 as an input of the batch normalization neural network

$$( e . g . , {μ}_{1}^{* t = 0} and {σ}_{1}^{* t = 0} ) .$$

According to an embodiment, the client device 14 may be configured to, in subjecting the advanced state 20 of the parametrization to a batch normalization folding, use a parametrization mapping 26a which maps a first set of bias b, mean parameter μ, standard deviation parameter σ², trainable batch normalization scaling parameter γ and trainable batch normalization offset parameter β onto a second set of bias b (e.g., \dot{β}), mean parameter μ (e.g., \dot{μ}), standard deviation parameter σ² (e.g., \dot{σ}²) trainable batch normalization scaling parameter γ (e.g., \dot{γ}) and trainable batch normalization offset parameter β (e.g., \dot{β}) according to

$$1 ) β := β + \frac{( b - μ ) * γ}{\sqrt{{σ}^{2} + ϵ}}$$

$$2 ) γ := γ \cdot \frac{\sqrt{θ + ϵ}}{\sqrt{{σ}^{2} + ϵ}}$$

with then setting

$$3 ) {σ}^{2} := θ$$

$$4 ) μ := 0$$

$$5 ) b := 0$$

wherein θ is 1 or 1−ϵ. As described above, such a mapping may allow transmitting a difference only for two of the five parameters

$$( e . g . , Δ {\dot{β}}_{s}^{t = 0} and Δ {\dot{γ}}_{s}^{t = 0} ) ,$$

which may allow lowering data transmission between client devise 14 and the server 12.

According to an embodiment, the client device 14 may be configured to, in sending the differential update 32 to the server 12, and/or receiving the averaged update 34 from the server 12, use a syntax element indicative of a batch normalization parametrization whose non-trainable statistical batch normalization parameters and bias are zero. For example, the syntax element may be indicative of the non-trainable statistical batch normalization parameters directly or indirectly, e.g., by indicating a re-parametrization mapping that defines the non-trainable statistical batch normalization parameters. The syntax element may index the non-trainable statistical batch normalization parameters and/or the re-parametrization mapping.

According to an embodiment, the client device 14 may be configured to, in sending the differential update 32 to the server 12, and/or receiving the averaged update 34 from the server 12, use for each parameter of a set of parameters including (e.g., at least) the non-trainable statistical batch normalization parameters and the bias, a syntax element which indicates whether all components of the respective parameter are equal to each other and have a predetermined value (e.g., zero or one or 1+some constant epsilon or 1−some constant epsilon), and, for each parameter of the set of parameters for which the syntax element indicates that all components of the respective parameter are equal to the predetermined value, a further syntax element indicating the predetermined value, and, for each parameter of the set of parameters for which the syntax element does not indicate that all components of the respective parameter are equal to each other and have the predetermined value, an entropy coding of the components of the respective parameter.

For example, the client device 14 may be configured to transmit a syntax element for each of the bias b, the mean parameter μ, and the standard deviation parameter σ² (e.g., in total three syntax element, e.g., three flags) that said three parameters are equal to a predetermined value (e.g., b=0, μ=0, and σ²=θ=1−ϵ). Furthermore, the client device 14 may be configured to transmit a syntax element for each of β and γ that said parameters are not equal to a predetermined value and to perform entropy coding of the components of the respective parameters of β and γ. However, the syntax elements may be signalled differently. For example, a single syntax element (e.g., flag) may signal collectively whether the parameters b, μ, and σ² are all equal to a predetermined value.

According to an embodiment, wherein the set of parameters further comprises at least one of the trainable batch normalization scaling parameter (e.g., γ) and the trainable batch normalization offset parameter (e.g., β). For example, the set of parameters may comprise or consist of β, γ, σ², μ, and b (or only some of these parameters).

According to an embodiment, the client device 14 may be configured to restrict the computation of the difference 22

$$( e . g . , Δ {W}_{1}^{t = 0} , Δ {\dot{γ}}_{1}^{t = 0} , and Δ {\dot{β}}_{1}^{t = 0} )$$

between the compressed advanced state of the parametrization and the compressed current state of the parametrization to weights

$$( e . g . , Δ {W}_{1}^{t = 0} = {\dot{W}}_{1}^{* , t = 0} - {\dot{W}}_{1}^{t = 0} ) ,$$

re-parametrized-domain trainable batch normalization scaling parameter

$$( e . g . , Δ {γ}_{1}^{t = 0} = {\dot{γ}}_{1}^{* t = 0} - {\dot{γ}}_{1}^{t = 0} )$$

and re-parametrized-domain trainable batch normalization offset parameter

$$( e . g . , Δ {β}_{1}^{t = 0} = {\dot{β}}_{1}^{* t = 0} - {\dot{β}}_{1}^{t = 0} ) .$$

For example, the client device 14 may not use any other values of these three parameters (e.g., that are related to W, γ, or β), or other parameters (e.g., b, μ, or σ²) for determining the difference 22.

According to an embodiment, the client device 14 may be configured to repeat the steps of performing the training of the batch normalization neural network, the subjecting to a batch normalization folding, the computation of the difference 22, the sending, the receiving and the updating 38 in consecutive communication rounds (e.g., for subsequently increasing round parameter t), wherein the current state 18 of the parametrization for a subsequent communication round is defined by the updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization for a current communication round. The compressed current state

$$( e . g . , {W}_{1}^{t = 1} , {\dot{b}}_{1}^{t = 1} , {\dot{μ}}_{1}^{t = 1} , {\dot{σ}}_{1}^{{2}^{t = 1}} , {\dot{γ}}_{1}^{t = 1} , and {\dot{β}}_{1}^{t = 1} )$$

of the parametrization for a subsequent communication round may be defined by weights

$$( e . g . , {W}_{1}^{t = 1} )$$

of the updated state 40 of the parametrization for the current communication round, and an updated re-parametrized-domain trainable batch normalization offset parameter (c.p. \dot{β}_{c}:=\dot{β}_{c}+Δ\dot{β}ₛ) and an updated re-parametrized-domain trainable batch normalization scaling parameter (c.p. \dot{γ}_{c}:=\dot{γ}_{c}+Δ\dot{γ}ₛ) computed, in the current communication round, by use of the received averaged re-parametrized-domain trainable batch normalization offset parameter difference, the received averaged re-parametrized-domain trainable batch normalization scaling parameter difference and a re-parametrized-domain trainable batch normalization offset parameter and a re-parametrized-domain trainable batch normalization scaling parameter of the current state 18 of the parametrization for the current communication round.

According to an embodiment, the data set 16 consists of one more instances of, or one or more of a combination of a picture, and/or a video, and/or an audio signal, and/or a text, and/or a temporal sensor signal, and the neural network is for performing inferences with using as an input, a picture, and/or a video, and/or an audio signal, and/or a text, and/or a temporal sensor signal.

According to an embodiment, the data set 16 may consist of one more instances of, or one or more of a combination of, a picture, and the neural network is for picture classification, object detection, picture segmentation or picture compression. Alternatively, the data set 16 may consist of one more instances of, or one or more of a combination of, a video, and the neural network is for video or scene classification, scene detection, video segmentation, object detection or video compression. Further alternatively, the data set 16 may consist of one more instances of, or one or more of a combination of, an audio signal, and the neural network is for audio classification, speech recognition or audio compression. The data set 16 may consist of one more instances of, or one or more of a combination of, a text, and the neural network is for extending the text, text segmentation or text classification, or the data set 16 may consist of one more instances of, or one or more of a combination of, a temporal sensor signal, and the neural network is for deriving a spectrogram of the temporal sensor signal.

The data set 16 may comprise instances and descriptors (e.g., in form of words or values) of instances that allow assessing a training of the parameters. The client devices 14 may have identical data sets 16, partially identical data sets (e.g., with a portion that is identical to at least one other client device and another portion that is exclusive to the client device 14) or data sets that are exclusive to each other (e.g., a result of a segmentation of an originally combined data set).

According to an embodiment, the neural network is for generating as an output a picture, and/or a video, and/or an audio signal, and/or a text.

According to an embodiment is provided a system 10 for federated averaging learning of a batch normalization neural network, comprising a server 12 (e.g., the server 12 depicted in FIG. 2), and one or more client devices 14 as described herein. The server 12 may be any server 12 as described herein. One or some or all the client devices 14 may be any of the client devices described herein.

According to an embodiment, the server 12 may be configured to receive the differential update 32 from the one or more client devices 14, perform an averaging over the re-parametrized-domain difference received from the one or more client devices 14 to obtain the received averaged re-parametrized-domain difference, send the averaged update 34 to the one or more client devices 14, the averaged update 34 comprising the received averaged re-parametrized-domain difference. The server 12 may be configured to perform a re-parametrized-domain parameter update by computing an updated re-parametrized-domain parametrization by the received averaged re-parametrized-domain difference and the re-parametrized-domain current state 28 of the parametrization.

According to an embodiment, the one or more client devices 14 are configured to perform training of neural networks that are batch normalization neural networks 12, wherein the re-parametrization mapping is batch normalization folding the differential update comprises the weight difference

$$( e . g . , Δ {W}_{1}^{t = 0} ) ,$$

the re-parametrized-domain trainable batch normalization offset parameter difference

$$( e . g . , Δ {\dot{β}}_{1}^{t = 0} )$$

and the re-parametrized-domain trainable batch normalization scaling parameter difference

$$( e . g Δ {\dot{γ}}_{1}^{t = 0} ) .$$

For example, the client devices 14 may be any client devices 14 described with reference to FIGS. 5 and 6.

The system 10 may be configured to receive the differential update 32 from the one or more client devices 14, perform an averaging over each of the weight difference

$$( e . g . , Δ {W}_{1}^{t = 0} ) ,$$

the re-parametrized-domain trainable batch normalization offset parameter difference

$$( e . g . , Δ {\dot{β}}_{1}^{t = 0} )$$

and the re-parametrized-domain trainable batch normalization scaling parameter difference

$$( e . g Δ {\dot{γ}}_{1}^{t = 0} )$$

received from the one or more client devices 14 to obtain the averaged weight difference

$$( e . g . , Δ {W}_{s}^{t = 0} )$$

(e.g., using equation 11), the received averaged re-parametrized-domain trainable batch normalization offset parameter difference

$$( e . g . , Δ {\dot{β}}_{s}^{t = 0} )$$

and the received averaged re-parametrized-domain trainable batch normalization scaling parameter difference

$$( e . g . , Δ {\dot{γ}}_{s}^{t = 0} ) .$$

The system 10 may further be configured to send the averaged update 34 to the one or more client devices 14, the averaged update 34 comprising the averaged weight difference

$$( e . g . , Δ {W}_{s}^{t = 0} ) ,$$

the received averaged re-parametrized-domain trainable batch normalization offset parameter difference

$$( e . g . , Δ {\dot{β}}_{s}^{t = 0} )$$

and the received averaged re-parametrized-domain trainable batch normalization scaling parameter difference

$$( e . g . , Δ {\dot{γ}}_{s}^{t = 0} ) .$$

The system 10 may further be configured to perform a re-parametrized-domain parameter update by updating 38 (c.p. W_{c}:=W_{c}+ΔWₛ) weights

$$( e . g . , {W}_{1}^{t = 0} )$$

of a currently stored parametrization state using the averaged weight difference, and computing an updated re-parametrized-domain trainable batch normalization offset parameter (c.p. \dot{β}_{c}:=\dot{β}_{c}+Δ\dot{β}ₛ) and an updated re-parametrized-domain trainable batch normalization scaling parameter (c.p. \dot{γ}_{c}:=\dot{γ}_{c}+Δ\dot{γ}ₛ) by use of the received averaged re-parametrized-domain trainable batch normalization offset parameter difference, the received averaged re-parametrized-domain trainable batch normalization scaling parameter difference and a re-parametrized-domain trainable batch normalization offset parameter and a re-parametrized-domain trainable batch normalization scaling parameter of a currently stored parametrization state.

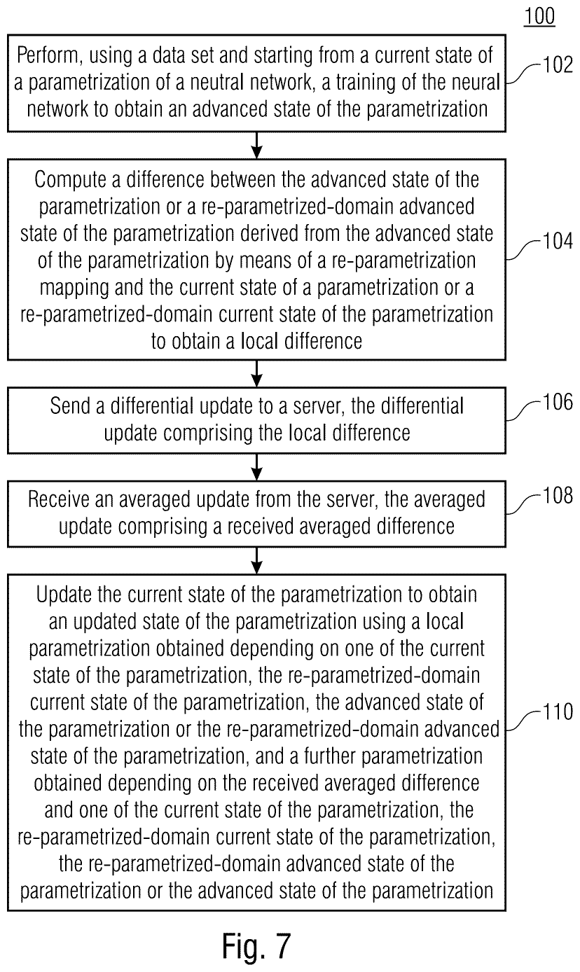

FIG. 7 shows a schematic flow diagram of a method 100 for participating in federated learning of a neural network. The method 100 may be performed by any client device 14 described herein. The method 100 may be performed by more than or all client devices of the system 10.

The method 100 comprises, in step 102, performing, using the data set 16 and starting from a current state 18

$$( e . g . , {W}_{1}^{t = 0} , {b}_{1}^{t = 0} , {μ}_{1}^{t = 0} , {σ}_{1}^{{2}^{t = 0}} , {γ}_{1}^{t = 0} , and {β}_{1}^{t = 0} )$$

of the parametrization of the neural network, a training of the neural network to obtain an advanced state 20

$$( e . g . , {W}_{1}^{* t = 0} , {b}_{1}^{* t = 0} , {μ}_{1}^{* t = 0} , {σ}_{1}^{{2}^{* t = 0}} , {γ}_{1}^{* t = 0} , and {β}_{1}^{* t = 0} )$$

of the parametrization.

The method 100 comprises, in step 104, computing a difference 22

$$( e . g . , Δ {\dot{W}}_{1}^{t = 0} , Δ {\dot{γ}}_{1}^{t = 0} , and Δ {\dot{β}}_{1}^{t = 0} )$$

between the advanced state 20 of the parametrization or a re-parametrized-domain advanced state 24 of the parametrization derived from the advanced state 20 of the parametrization by means of a re-parametrization mapping 26a, b and the current state 18

$$( e . g . , {W}_{1}^{t = 0} , {b}_{1}^{t = 0} , {μ}_{1}^{t = 0} , {σ}_{1}^{{2}^{t = 0}} , {γ}_{1}^{t = 0} , and {β}_{1}^{t = 0} )$$

of a parametrization or a re-parametrized-domain current state 28 of the parametrization to obtain a local difference 30.

The method 100 comprises, in step 106, sending a differential update 32 to a server 12, the differential update 32 comprising the local difference 30.

The method 100 comprises, in step 108, receiving an averaged update 34 from the server 12, the averaged update 34 comprising a received averaged difference 36.

The method 100 comprises, in step 110, updating 38 the current state 18 of the parametrization to obtain an updated state 40

$$( e . g . , {W}_{1}^{t = 1} , {b}_{1}^{t = 1} , {μ}_{1}^{t = 1} , {σ}_{1}^{{2}^{t = 1}} , {γ}_{1}^{t = 1} , and {β}_{1}^{t = 1} )$$

of the parametrization using a local parametrization 42 obtained depending on one of the current state 18 of the parametrization, the re-parametrized-domain current state 28 of the parametrization, the advanced state 20 of the parametrization or the re-parametrized-domain advanced state 24 of the parametrization, and a further parametrization 44 obtained depending on the received averaged difference 36 and one of the current state 18 of the parametrization, the re-parametrized-domain current state 28 of the parametrization, the re-parametrized-domain advanced state 24 of the parametrization or the advanced state 20 of the parametrization.

The method 100 realizes the advantages of the client device 14 disclosed herein such as improving a compromise between stability and learning progress.

The method 100 may include any functionality or step of the client device 14 disclosed herein.

In the following, features and advantages of the client device 14, the system 10, and the method 100 are described again, partly in different words. Any feature described in the following can be implemented in any combination in any disclosure above and any feature described above can implemented in any combination in any of the following disclosure.

In an advanced setting, e.g., in an embodiment of the client device 14, the client parameter update is parameterized by a weighting factor η, an update shifting hyperparameter B and an update scaling hyperparameter [symbol] according to equation 13:

$${ρ}_{c} := ( 1 - η ) {ρ}_{c} + η ( B + ς ( {ρ}_{c} + Δ {ρ}_{s} ) ) \qquad equation ( 13 )$$

ρ can be a parameter of any neural network layer parameter type (e.g., W_{c}, b_{c}, μ_{c}, σ_{c}², γ_{c}, and β_{c}). For example, for η=0, the client update may consider only the locally available parameter states, e.g., the current state ρ_{c} or its optimized state resulting from the latest training round using gradient descent optimization,

$${ρ}_{c}^{*} ( e . g . , {ρ}_{c}^{*}$$

instead of ρ_{c} for the first summand in equation 13). For example, for η=1, B=0 and [symbol] =1, a base update setting may be applied, which—to recap—adds the aggregated server difference update to the local parameter state, i.e., ρ_{c}:=ρ_{c}+Δρₛ. However, to correct the update on the client side, e.g., to prevent client drift, to promote personalized federated learning, or to optimize the federated learning system in terms of its data compressibility, η, B, and [symbol] might be utilized. Choosing 0<η<1 incorporates local parameter states and global knowledge from the federated learning system.

For example, depending on η, B and [symbol] , the setting of the following options are possible to compute an updated state (e.g., updated state 40): 1) keeping local parameters (i.e., the estimated state update is equal to the current state), 2) using the latest advanced state (e.g., W*), 3) using a (possibly weighted and) possibly reparameterized difference to update the current state (e.g., update the current state 18 of the parametrization).

Shifting and scaling the global knowledge (e.g., further parametrization 44) using B and [symbol] might be used to, e.g., reverse a previously applied parameter transformation (e.g., re-parametrization mapping 26 a, b) as exemplarily used in the embodiment described below where such transformation is embodied by a folding operation with respect to BN parameters or to scale and shift the resulting update of ρ_{c}+Δρₛ using, e.g., similarity metrics or weight relevances as derived from explainable AI (XAI) algorithms like ECQ^{x} (Becking, Dreyer, et al., 2022). In another scenario, the update scaling parameters [symbol] could be trained using gradient descent methods, e.g., as described in (Becking, Kirchhoffer, et al., 2022).

The description of batch norm parameter modifications as presented in patent WO2021209469A1 is incorporated herein by reference.

Introducing a constant scalar value θ which, for example could be equal to 1 or 1−ϵ, parameters b, μ, σ², γ, and β can be modified by the following ordered steps without changing the result of BN(X):

$$β := β + \frac{( b - μ ) * γ}{\sqrt{{σ}^{2} + ϵ}} \qquad 1 )$$

$$γ := γ \cdot \frac{\sqrt{θ + ϵ}}{\sqrt{{σ}^{2} + ϵ}} \qquad 2 )$$

$${σ}^{2} := θ \qquad 3 )$$

$$μ := 0 \qquad 4 )$$

$$b := 0 \qquad 5 )$$

Each of the operations shall be interpreted as element-wise operations on the elements of the transposed vectors. Further modifications that don't change BN(X) are also possible. For example, bias b and mean μ are ‘integrated’ in β so that b and μ are afterwards set to 0. Or σ² could be set to 1−ϵ (i.e., θ=1−ϵ) in order to set the denominator of the fraction in BN(X) equal to 1 when other parameters are adjusted accordingly.

As a result, σ², μ and b can be compressed much more efficiently as all vector elements have the same value.

In an embodiment, a flag (e.g., a syntax element) is encoded that indicates whether all elements of a parameter have a predefined constant value. A parameter may, for example, be b, μ, σ², γ, or β. Predefined values may, for example, be 0, 1, or 1−ϵ. For example, if the flag is equal to 1, all vector elements of the parameter are set to the predefined value. Otherwise, the parameter is encoded using one of the state-of-the-art parameter encoding methods, like, e.g., DeepCABAC (Wiedemann et al., 2020).

### Embodiment Regarding the Compression of Batch Norm Parameter Updates in Federated Averaging Applications

In a Federated Averaging scenario, as illustrated in FIG. 2, the compression of batch norm parameters as described in the previous subsection may not be fully applicable, e.g., because the modifications described in 1) to 5) of that subsection are irreversible (e.g., in scenarios that do not take the modification in account at a later stage). Hence, the reconstruction of batch norm parameters such as μ or σ², which usually represent the running means and variances of a neural network layer's hidden activations, or γ and β, which usually represent trainable scale- and shift-vectors, may not be possible after applying the modifications (e.g., re-parametrization mapping). However, during federated learning, those parameters, or their differential updates 32 (e.g., Δμ, Δσ², Δγ and Δβ) may be crucial for successful training of the global (server 12) and local (client or client device 14) neural network models. In the following, the modified batch norm parameters are indicated \dot{μ}, \dot{σ}², γ and \dot{β}.

In an embodiment, all clients are provided with an identical set of parameters (e.g., for μ, β, b, σ², and γ) by the server 12. For example, if the initial model has no prior knowledge, the elements of the batch norm parameters may be initialized with 0 for all μ, β and b and 1 for all σ² and γ.

For FedBNF, first, a copy of the modified batch norm parameters \dot{μ}, \dot{σ}², \dot{γ} and \dot{β} is stored locally on the server 12 and client devices 14. Second, the layers of the client neural networks are trained, yielding W*_{c}, b*_{c}, μ*_{c}, σ*_{c}², γ*_{c}, and β*_{c}. Third, the updated parameters are modified according to 1) to 5) of the previous subsection, yielding \dot{b}*_{c}, \dot{μ}*_{c}, \dot{σ}*_{c}², \dot{γ}*_{c}, and \dot{β}*_{c}. Fourth, the differential client updates are computed layer-wise, i.e.,

$$Δ {W}_{c} = {W}_{c}^{*} - {W}_{c}$$

$$Δ \dot{{γ}_{c}} = \dot{{γ}_{c}^{*}} * {\dot{γ}}_{c}$$

$$Δ {\dot{β}}_{c} = \dot{{β}_{c}^{*}} - \dot{{β}_{c}} .$$

The remaining differential layer parameter updates, i.e., Δ\dot{σ}², Δ\dot{μ} and Δ\dot{b}, shall not (or may not be required to) be transmitted to the server 12, since their information is implicitly included in the modified \dot{γ} and \dot{β} and thus in their differential updates 32. Fifth, at the server 12, all received client updates are aggregated through layer-wise averaging, i.e.,

$$Δ {W}_{s} = \frac{1}{N} {\sum }_{c ∈ N}^{N} Δ {W}_{c}$$

$$Δ {\dot{γ}}_{s} = \frac{1}{N} {\sum }_{c ∈ N}^{N} Δ \dot{{γ}_{c}}$$

$$Δ {\dot{β}}_{s} = \frac{1}{N} {\sum }_{c ∈ N}^{N} Δ {\dot{β}}_{c} .$$

For example, the server instance s only operates in the modified parameter domain adding ΔWₛ to Wₛ, and Δ\dot{γ}ₛ and Δ\dot{β}ₛ to its modified \dot{γ}ₛ and \dot{β}ₛ. All \dot{μ}ₛ, \dot{σ}ₛ² elements may remain unchanged throughout the federated training, i.e., 0 and 1. Then, sixth, the aggregated differential updates 32 (e.g., ΔWₛ, Δ\dot{γ}ₛ and Δ\dot{β}ₛ) are broadcasted to the client instances, where the weight update ΔWₛ is added to the according client's base neural network parameter W_{c}, i.e., W_{c}:=W_{c}+ΔWₛ. The clients' batch norm parameters may be updated according to:

$${γ}_{c} := ( 1 - η ) \cdot {γ}_{c}^{*} + η \cdot \sqrt{{σ}_{c}^{* 2} + ϵ} \cdot {\dot{γ}}_{c}$$

$${β}_{c} := ( 1 - η ) \cdot {β}_{c}^{*} + η \cdot ( {μ}_{c}^{*} \cdot {\dot{γ}}_{c} + {\dot{β}}_{c} )$$

$$with {\dot{γ}}_{c} := \dot{{γ}_{c}} + Δ \dot{{γ}_{s}} and {\dot{β}}_{c} := \dot{{β}_{c}} + Δ \dot{{β}_{s}} .$$

It is noted that, in this example, \dot{γ}_{c} and \dot{β}_{c} are identical with \dot{γ}ₛ and \dot{β}ₛ for all c, since the server 12 provides all clients with an identical set of initial parameters and thus the untrained parameters (without the superscript “*”) remain in sync by adding identical server updates in each communication round.

The running statistics buffers of the client instances, i.e., μ_{c} and

$${σ}_{c}^{2}$$

remain unchanged, respectively their latest states are used to continue training with their local data:

$${μ}_{c} := {μ}_{c}^{*} and {σ}_{c}^{2} := {σ}_{c}^{{*}^{2}} .$$

After updating 38

$$( e . g . , {W}_{c} , {γ}_{c} , {β}_{c} , {\dot{γ}}_{c} , {\dot{β}}_{c} , {μ}_{c} and {σ}_{c}^{2} )$$

for all clients c, as described above, the steps second to sixth are repeated for t communication rounds until the global sever neural network reached a converged state.

η∈[0, 1] is a momentum hyperparameter to control the amount of local batch norm adaptation and global batch norm information. The latter increases global information sharing and prevents client drift compared to the former term which emphasizes local batch norm statistics (adapted to the client's data), which in turn is important for client model convergence. In practice an η∈[0.1, 0.4] works well in a number of use cases (Becking et al., 2024). However, it can also be fine-tuned and be adapted per communication round.

Although some aspects have been described in the context of an apparatus, it is clear that these aspects also represent a description of the corresponding method, where a block or device corresponds to a method step or a feature of a method step.

Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

The inventive digital data, data stream or file containing the inventive NN representation can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

Becking, D., Müller, K., Haase, P., Kirchhoffer, H., Tech, G., Samek, W., Schwarz, H., Marpe, D. & Wiegand, T. (2024). Neural Network Coding of Difference Updates for Efficient Distributed Learning Communication. IEEE Transactions on Multimedia.
Becking, D., Dreyer, M., Samek, W., Müller, K., & Lapuschkin, S. (2022). ECQx: Explainability-Driven Quantization for Low-Bit and Sparse DNNs. In A. Holzinger, R. Goebel, R. Fong, T. Moon, K.-R. Müller, & W. Samek (Eds.), XxAI—Beyond Explainable AI: International Workshop, Held in Conjunction with ICML 2020, Vien-na, Austria, Revised and Extended Papers (pp. 271-296).
Becking, D., Kirchhoffer, H., Tech, G., Haase, P., Müller, K., Schwarz, H., & Samek, W. (2022). Adaptive Differential Filters for Fast and Communication-Efficient Federated Learning. 3367-3376.
Chetlur, S., Woolley, C., Vandermersch, P., Cohen, J., Tran, J., Catanzaro, B., & Shelhamer, E. (2014). cuDNN: Efficient Primitives for Deep Learning (arXiv:1410.0759)
Ioffe, S., & Szegedy, C. (2015). Batch Normalization: Accelerating Deep Network Training by Reducing Internal Covariate Shift. Proceedings of the 32nd International Conference on Machine Learning, 448-456.
McMahan, H. B., Moore, E., Ramage, D., & Hampson, S. (2017). Communication-Efficient Learning of Deep Networks from Decentralized Data. Proceedings of the 20th International Conference on Artificial Intelligence and Statistics, 54, 1273-1282.
Wiedemann, S., Kirchhoffer, H., Matlage, S., Haase, P., Marban, A., Marinč, T., Neumann, D., Nguyen, T., Schwarz, H., Wiegand, T., Marpe, D., & Samek, W. (2020). DeepCABAC: A Universal Compression Algorithm for Deep Neural Networks. IEEE Journal of Selected Topics in Signal Processing, 14(4), 700-714.

1. A client device for participating in federated learning of a neural network, configured to
perform, using a data set and starting from a current state of a parametrization of the neural network, a training of the neural network to acquire an advanced state of the parametrization;
compute a difference between the advanced state of the parametrization or a re-parametrized-domain advanced state of the parametrization derived from the advanced state of the parametrization by means of a re-parametrization mapping and the current state of a parametrization or a re-parametrized-domain current state of the parametrization to acquire a local difference;
send a differential update to a server, the differential update comprising the local difference;
receive an averaged update from the server, the averaged update comprising a received averaged difference;
update the current state of the parametrization to acquire an updated state of the parametrization using
a local parametrization acquired depending on one of the current state of the parametrization, the re-parametrized-domain current state of the parametrization, the advanced state of the parametrization or the re-parametrized-domain advanced state of the parametrization, and
a further parametrization acquired depending on the received averaged difference and one of the current state of the parametrization, the re-parametrized-domain current state of the parametrization, the re-parametrized-domain advanced state of the parametrization or the advanced state of the parametrization.

2. The client device of claim 1, configured to compute the further parametrization using the received averaged difference and the re-parametrized-domain current state of the parametrization.

3. The client device of claim 1, configured to derive the local parametrization from the advanced state of the parametrization.

4. The client device of claim 1, configured to compute the further parametrization by correcting the re-parametrized-domain current state of the parametrization using the received averaged difference to acquire a corrected re-parametrized-domain state and subjecting the corrected re-parametrized-domain state to an affine transformation.

5. The client device of claim 1, configured to update the current state of the parametrization using a weighted sum between the local parametrization on the one hand and the further parametrization on the other hand.

6. The client device of claim 1, configured to update the current state of the parametrization, for at least one parameter of the current state of the parametrization, according to
$${ρ}_{c} := ( 1 - η ) {ρ}_{c}^{l o c a l} + η ( B + ς ( {ρ}_{c}^{′ local} + Δ {ρ}_{s} ) ) ,$$
wherein
η is a weighting factor, B is an update shifting hyper parameter and [symbol] is an update scaling hyper parameter, and
$${ρ}_{c}^{l o c a l}$$
is the current state of the parametrization or the advanced state of the parametrization or depends on the current state of the parametrization and/or the advanced state of the parametrization, and
$${ρ}_{c}^{′ local}$$
is the current state of the parametrization or the advanced state of the parametrization or depends on the current state of the parametrization and/or the advanced state of the parametrization, or the re-parametrized-domain current state of the parametrization or the re-parametrized-domain advanced state of the parametrization or depends on the re-parametrized-domain current state of the parametrization and/or the re-parametrized-domain advanced state of the parametrization and
Δρₛ is the received averaged difference, and
ρ_{c} is the updated state of the parametrization.

7. The client device of claim 6, wherein B is an update shifting hyper parameter and [symbol] is an update scaling hyper parameter that
are to estimate a reversal of the re-parametrization mapping with
$${ρ}_{c}^{′ local}$$
being the re-parametrized-domain advanced state of the parametrization or depending on the re-parametrized-domain current state of the parametrization and/or the re-parametrized-domain advanced state of the parametrization, and
are depending on similarity metrics or weight relevances acquired from a parametrization of the neural network, or
are trained during the training of the neural network.

8. The client device of claim 1, configured to
subject the advanced state of the parametrization to the re-parametrization mapping to acquire the re-parametrized-domain advanced state of the parametrization;
compute the local difference as a difference between the re-parametrized-domain advanced state of the parametrization and the re-parametrized-domain current state of the parametrization;
send the differential update to the server so that the differential update comprises the re-parametrized-domain difference; and
receive the averaged update from the server with the averaged update comprising an averaged re-parametrized-domain difference.

9. The client device of claim 1, configured to update the current state of the parametrization by
with respect to at least one parameter of the current state of the parametrization, performing a weighted summation between
a corresponding parameter of the advanced state of the parametrization, on the one hand, and
an estimated state update for a corresponding parameter of the current state of the parametrization acquired by means of an updated re-parametrized-domain state of the parametrization derived from the received averaged re-parametrized-domain difference and the re-parametrized-domain current state of the parametrization, on the other hand.

10. The client device of claim 9, configured to perform the training of the neural network by using a gradient descent algorithm to optimize weights of the current state of the parametrization, a bias of the current state of the parametrization, and the at least one parameter of the current state of the parametrization.

11. The client device of claim 10, configured to, in computing the difference between the re-parametrized-domain advanced state of the parametrization and the re-parametrized-domain current state of the parametrization, compute differences between weights of the re-parametrized-domain advanced state of the parametrization and the re-parametrized-domain current state of the parametrization and between a re-parametrized-domain parameter of the re-parametrized-domain advanced state of the parametrization and the re-parametrized-domain current state of the parametrization.

12. The client device of claim 9, configured to repeat the performing the training of the neural network, the subjecting to a re-parametrization mapping, the computation of the difference, the sending, the receiving and the updating in consecutive communication rounds,
wherein the current state of the parametrization for a subsequent communication round is defined by the updated state of the parametrization for a current communication round, and
wherein the re-parametrized-domain current state of the parametrization for a subsequent communication round is defined by an updated re-parametrized-domain state of the parametrization for the current communication round computed, in the current communication round, by use of the received averaged re-parametrized-domain difference and the re-parametrized-domain current state of the parametrization for the current communication round.

13. The client device of claim 9, configured to, in sending the differential update to the server, and/or receiving the averaged update from the server, use a syntax element indicative of a use of a re-parametrized-domain for transmission.

14. The client device of claim 9, configured to
use the received averaged re-parametrized-domain difference to update the re-parametrized-domain current state of the parametrization, and
in updating the current state of the parametrization to acquire an updated state of the parametrization, determine the estimated state update for the corresponding parameter of the current state of the parametrization acquired by subjecting the updated re-parametrized-domain state of the parametrization to an affine transformation.

15. The client device of claim 14, configured to derive the updated re-parametrized-domain state of the parametrization by a summation of the received averaged re-parametrized-domain difference and the re-parametrized-domain current state of the parametrization.

16. The client device according to claim 9, wherein
the neural network is a batch normalization neural network,
the re-parametrization mapping is a batch normalization folding, the re-parametrized-domain advanced state of the parametrization being equivalent, in terms of inference result, to the advanced state of the parametrization;
the computation of a difference between the re-parametrized-domain advanced state of the parametrization and a re-parametrized-domain current state of the parametrization yields a weight difference, a re-parametrized-domain trainable batch normalization offset parameter difference and a re-parametrized-domain trainable batch normalization scaling parameter difference;
the differential update comprises the weight difference, the re-parametrized-domain trainable batch normalization offset parameter difference and the re-parametrized-domain trainable batch normalization scaling parameter difference;
the averaged update comprises a received averaged weight difference, a received averaged re-parametrized-domain trainable batch normalization offset parameter difference and a received averaged re-parametrized-domain trainable batch normalization scaling parameter difference;
the updating the current state of the parametrization to acquire an updated state of the parametrization involves
with respect to a trainable batch normalization offset parameter of the current state of the parametrization, performing a weighted summation between a trainable batch normalization offset parameter of the advanced state of the parametrization, on the one hand, and an estimated state update for a trainable batch normalization offset parameter of the current state of the parametrization acquired by means of the received averaged re-parametrized-domain trainable batch normalization offset parameter difference, on the other hand, and
with respect to a trainable batch normalization scaling parameter of the current state of the parametrization, performing a weighted summation between a trainable batch normalization scaling parameter of the advanced state of the parametrization, on the one hand, and an estimated state update for a trainable batch normalization scaling parameter of the current state of the parametrization acquired by means of the received averaged re-parametrized-domain trainable batch normalization scaling parameter difference, on the other hand.

17. The client device of claim 16, configured to
update the current state of the parametrization to acquire the updated state of the parametrization by
updating weights of the current state of the parametrization using the averaged weight difference.

18. The client device of claim 17, configured to update the weights of the current state of the parametrization using the averaged weight difference by computing a sum of the weights of the current state of the parametrization and the averaged weight difference.

19. The client device of claim 16, configured to
update the current state of the parametrization to acquire the updated state of the parametrization by
computing an updated re-parametrized-domain trainable batch normalization offset parameter and an updated re-parametrized-domain trainable batch normalization scaling parameter by use of the received averaged re-parametrized-domain trainable batch normalization offset parameter difference, the received averaged re-parametrized-domain trainable batch normalization scaling parameter difference and a re-parametrized-domain trainable batch normalization offset parameter and a re-parametrized-domain trainable batch normalization scaling parameter of the current state of the parametrization,
computing the estimated state update for the trainable batch normalization offset parameter of the current state of the parametrization and the estimated state update for the trainable batch normalization scaling parameter of the current state of the parametrization based on the updated re-parametrized-domain trainable batch normalization offset parameter and the updated re-parametrized-domain trainable batch normalization scaling parameter, and
non-trainable statistical batch normalization parameters of the advanced state of the parametrization,
updating a trainable batch normalization offset parameter of the current state of the parametrization using a first weighted sum of the trainable batch normalization offset parameter of the advanced state of the parametrization, and the estimated state update for the trainable batch normalization offset parameter, and a trainable batch normalization scaling parameter of the current state of the parametrization using a second weighted sum of the trainable batch normalization scaling parameter of the advanced state of the parametrization and the estimated state update for the trainable batch normalization scaling parameter.

20. The client device of claim 19, configured so that, in the first weighted sum, the trainable batch normalization offset parameter of the advanced state of the parametrization forms a first summand which is weighted by a first factor and the estimated state update for the trainable batch normalization offset parameter forms a second summand which is weighted by a second factor, and in the second weighted sum, the trainable batch normalization scaling parameter of the advanced state of the parametrization forms a third summand which is weighted by the first factor and the estimated state update for the trainable batch normalization scaling parameter forms a fourth summand which is weighted by the second factor.

21. The client device of claim 20, configured so that the first and second factors sum-up to 1.

22. The client device of claim 20, configured so that the first and second factors are fixed by default or the client device is configured to determine same from a corresponding message from the server.

23. The client device of claim 20, configured so that the second factor is within interval [0.1, 0.4].

24. The client device of claim 19, configured to compute the estimated state update for the trainable batch normalization scaling parameter of the current state of the parametrization based on the updated re-parametrized-domain trainable batch normalization scaling parameter, and a standard deviation parameter of the non-trainable statistical batch normalization parameters of the advanced state of the parametrization, and the estimated state update for the trainable batch normalization offset parameter of the current state of the parametrization based on the updated re-parametrized-domain trainable batch normalization offset parameter, the updated re-parametrized-domain trainable batch normalization scaling parameter, and a mean parameter of the non-trainable statistical batch normalization parameters of the advanced state of the parametrization.

25. The client device of claim 16, configured to update the current state of the parametrization to acquire the updated state of the parametrization by
adopting non-trainable statistical batch normalization parameters of the advanced state of the parametrization as non-trainable statistical batch normalization parameters of the updated state of the parametrization.

26. The client device of claim 16, configured to perform the training of the batch normalization neural network by using a gradient descent algorithm to optimize weights of the current state of the parametrization, a bias of the current state of the parametrization, the trainable batch normalization offset parameter of the current state of the parametrization, and the trainable batch normalization scaling parameter of the current state of the parametrization.

27. The client device of claim 16, configured to, in performing the training of the batch normalization neural network, compute non-trainable statistical batch normalization parameters of the advanced state of the parametrization, perform a mean and variance computation on hidden activations of the batch normalization neural network encountered when using the data set as an input of the batch normalization neural network.

28. The client device of claim 16, configured to, in subjecting the advanced state of the parametrization to a batch normalization folding, use a parametrization mapping which maps a first set of bias b, mean parameter β, standard deviation parameter σ², trainable batch normalization scaling parameter γ and trainable batch normalization scaling parameter β onto a second set of bias b, mean parameter μ, standard deviation parameter σ², trainable batch normalization scaling parameter γ and trainable batch normalization offset parameter β according to
$$β := β + \frac{( b - μ ) * γ}{\sqrt{{σ}^{2} + ϵ}}$$
$$γ := γ \cdot \frac{\sqrt{θ + ϵ}}{\sqrt{{σ}^{2} + ϵ}}$$
with then setting
$${σ}^{2} := θ$$
$$μ := 0$$
$$b := 0$$
wherein θ is 1 or 1−∈.

29. The client device of claim 16, configured to, in sending the differential update to the server, and/or receiving the averaged update from the server, use a syntax element indicative of a batch normalization parametrization whose non-trainable statistical batch normalization parameters and bias are zero.

30. The client device according to claim 19, configured to, in sending the differential update to the server, and/or receiving the averaged update from the server, use
for each parameter of a set of parameters comprising the non-trainable statistical batch normalization parameters and the bias,
a syntax element which indicates whether all components of the respective parameter are equal to each other and comprise a predetermined value, and,
for each parameter of the set of parameters for which the syntax element indicates that all components of the respective parameter are equal to the predetermined value,
a further syntax element indicating the predetermined value, and,
for each parameter of the set of parameters for which the syntax element does not indicate that all components of the respective parameter are equal to each other and comprise the predetermined value,
an entropy coding of the components of the respective parameter.

31. The client device of claim 30, wherein the set of parameters further comprises at least one of the trainable batch normalization scaling parameter and the trainable batch normalization offset parameter.

32. The client device of claim 31, configured to restrict the computation of the difference between the compressed advanced state of the parametrization and the compressed current state of the parametrization to weights, re-parametrized-domain trainable batch normalization scaling parameter and re-parametrized-domain trainable batch normalization offset parameter.

33. The client device of claim 16, configured to repeat the performing the training of the batch normalization neural network, the subjecting to a batch normalization folding, the computation of the difference, the sending, the receiving and the updating in consecutive communication rounds,
wherein the current state of the parametrization for a subsequent communication round is defined by the updated state of the parametrization for a current communication round, and
wherein the compressed current state of the parametrization for a subsequent communication round is defined by
weights of the updated state of the parametrization for the current communication round, and
an updated re-parametrized-domain trainable batch normalization offset parameter and an updated re-parametrized-domain trainable batch normalization scaling parameter computed, in the current communication round, by use of the received averaged re-parametrized-domain trainable batch normalization offset parameter difference, the received averaged re-parametrized-domain trainable batch normalization scaling parameter difference and a re-parametrized-domain trainable batch normalization offset parameter and a re-parametrized-domain trainable batch normalization scaling parameter of the current state of the parametrization for the current communication round.

34. The client device according to claim 1, wherein
the data set comprises one or more instances of, or one or more of a combination of, and
the neural network is for performing inferences with using as an input,
a picture, and/or
a video, and/or
an audio signal, and/or
a text, and/or
a temporal sensor signal.

35. The client device according to claim 1, wherein
the data set comprises one or more instances of, or one or more of a combination of, a picture, and the neural network is for picture classification, object detection, picture segmentation or picture compression,
the data set comprises one or more instances of, or one or more of a combination of, a video, and the neural network is for video or scene classification, scene detection, video segmentation, object detection or video compression, or
the data set comprises one or more instances of, or one or more of a combination of, an audio signal, and the neural network is for audio classification, speech recognition or audio compression, or
the data set comprises one or more instances of, or one or more of a combination of, a text, and the neural network is for extending the text, text segmentation or text classification, or
the data set comprises one or more instances of, or one or more of a combination of, a temporal sensor signal, and the neural network is for deriving a spectrogram of the temporal sensor signal.

36. The client device according to claim 1, wherein the neural network is for generating as an output
a picture, and/or
a video, and/or
an audio signal, and/or
a text.

37. A method for participating in federated learning of a neural network, the method comprising
performing, using a data set and starting from a current state of a parametrization of the neural network, a training of the neural network to acquire an advanced state of the parametrization;
computing a difference between the advanced state of the parametrization or a re-parametrized-domain advanced state of the parametrization derived from the advanced state of the parametrization by means of a re-parametrization mapping and the current state of a parametrization or a re-parametrized-domain current state of the parametrization to acquire a local difference;
sending a differential update to a server, the differential update comprising the local difference;
receiving an averaged update from the server, the averaged update comprising a received averaged difference;
updating the current state of the parametrization to acquire an updated state of the parametrization using
a local parametrization acquired depending on one of the current state of the parametrization, the re-parametrized-domain current state of the parametrization, the advanced state of the parametrization or the re-parametrized-domain advanced state of the parametrization, and
a further parametrization acquired depending on the received averaged difference and one of the current state of the parametrization, the re-parametrized-domain current state of the parametrization, the re-parametrized-domain advanced state of the parametrization or the advanced state of the parametrization.

38. A system for federated averaging learning of a batch normalization neural network, comprising
a server, and
one or more client devices according to claim 1.

39. The system of claim 38, wherein the server is configured to
receive the differential update from the one or more client devices,
perform an averaging over the re-parametrized-domain difference received from the one or more client devices to acquire the received averaged re-parametrized-domain difference;
send the averaged update to the one or more client devices, the averaged update comprising the received averaged re-parametrized-domain difference; and
perform a re-parametrized-domain parameter update by
computing an updated re-parametrized-domain parametrization by the received averaged re-parametrized-domain difference and the re-parametrized-domain current state of the parametrization.

40. The system of claim 38, wherein the one or more client devices are according to claim 16 and the server is configured to
receive the differential update from the one or more client devices,
perform an averaging over each of the weight difference, the re-parametrized-domain trainable batch normalization offset parameter difference and the re-parametrized-domain trainable batch normalization scaling parameter difference received from the one or more client devices to acquire the averaged weight difference, the received averaged re-parametrized-domain trainable batch normalization offset parameter difference and the received averaged re-parametrized-domain trainable batch normalization scaling parameter difference;
send the averaged update to the one or more client devices, the averaged update comprising the averaged weight difference, the received averaged re-parametrized-domain trainable batch normalization offset parameter difference and the received averaged re-parametrized-domain trainable batch normalization scaling parameter difference; and
perform a re-parametrized-domain parameter update by
updating weights of a currently stored parametrization state using the averaged weight difference, and
computing an updated re-parametrized-domain trainable batch normalization offset parameter and an updated re-parametrized-domain trainable batch normalization scaling parameter by use of the received averaged re-parametrized-domain trainable batch normalization offset parameter difference, the received averaged re-parametrized-domain trainable batch normalization scaling parameter difference and a re-parametrized-domain trainable batch normalization offset parameter and a re-parametrized-domain trainable batch normalization scaling parameter of a currently stored parametrization state.
